(19) United States
(12) Patent Application Publication
(10) Pub. No.: US 2014/0033012 A1
(43) Pub. Date: Jan. 30, 2014

(54) Time-based optional portion in electronic content

(71) Applicants: Samreen Dhillon, Jalandhar (IN); Harshdeep Singh, Pitampura (IN)

(72) Inventors: Samreen Dhillon, Jalandhar (IN); Harshdeep Singh, Pitampura (IN)

(73) Assignee: Adobe Systems Incorporated

(21) Appl. No.: 11/506,556

(22) Filed: Aug. 17, 2006

(51) Int. Cl. G06F 17/22

(52) U.S. Cl. CPC G06F 17/2288
USPC 715/229

(57) ABSTRACT

A method comprising creating association data that associates a content element and active time period data, the content element being associated with an electronic content, and the active time period data specifying a time period during which the electronic content includes the content element, and storing the association data. A second method comprising accessing electronic content, the electronic content being associated with a content element and active time period data, the active time period data specifying a time period during which the association between the electronic content and the content element is active, receiving current time period data, using the current time period data and the active time period data, determining whether the association between the electronic content and the content element is active, and selectively rendering the content element, based on the determination.

### FIELD

This application relates to a method and system to selectively enable access to electronic content, and, in one example embodiment, to enable time-based access to portions of electronic content.

### BACKGROUND

In recent years, as the amount of digital and electronic content has proliferated at an exponential rate, particularly that available via the Internet, the need for content to be accessible in a time-dependent manner is beginning to be felt. For example, producers of digital content, in anticipation that content they create will be available on the Internet for a long period of time, find the task of keeping track of the currency of their content and editing it to keep it up-to-date to be a tedious and error-prone task.

Aggravating this maintenance issue, many search engines cache and store digital content for a significant period of time, during which time cached copies of the content are available via the search engine but are not directly accessible for maintenance by their original authors. During this period, the cached content can easily become partially or even completely obsolete, without any indication of this obsolescence provided to the viewer of the digital content.

While it may sometimes be possible for viewers of a piece of electronic content to obtain a current version of an item of digital content or to determine what portions of such an item are obsolete or not yet relevant, the viewers may be burdened or inconvenienced by having to search for a current version or determine obsolete or relevant portions of a document.

### BRIEF DESCRIPTION OF DRAWINGS

Some embodiments are illustrated by way of example and not limitation in the Figures of the accompanying drawings in which:

FIG. 1 is a diagrammatic representation of a computer screen showing a view of an electronic content associated with at least two content elements during a first time period, according to an example embodiment.

FIG. 2 is a diagrammatic representation of a computer screen showing a view of an electronic content associated with at least two content elements during a second time period, according to an example embodiment.

FIG. 3 is a diagrammatic representation of electronic content as it may be stored in a computer-readable medium as used in an example embodiment.

FIG. 4 is a further diagrammatic representation of electronic content as it may be stored in a computer-readable medium as used in an example embodiment.

FIG. 5 is a yet further diagrammatic representation of electronic content as it may be stored in a computer-readable medium as used in an example embodiment.

FIG. 6 is a diagrammatic representation of a file structure by which content elements may be associated with pages of an electronic document by using time-based optional content groups as used in an example embodiment.

FIG. 7 is a further diagrammatic representation of a file structure by which content elements may be associated with pages of an electronic document by using time-based optional content groups as used in an example embodiment.

FIG. 8 is a yet further diagrammatic representation of a file structure by which content elements may be associated with pages of an electronic document by using time-based optional content groups and a file catalogue as used in an example embodiment.

FIG. 9 is a diagrammatic representation of a data structure stored in three separate files by which content elements may be associated with electronic content and with active time period data as used in an example embodiment.

FIG. 10 is a diagrammatic representation of a file structure, such as that which may be used by, for example, ADOBE® portable document format (PDF), to associate content elements with electronic content, where the electronic content is organized, among other methods, into pages as used in an example embodiment.

FIG. 11 is a diagrammatic representation of the file structure illustrated in FIG. 10, as it may appear after it has been updated to associate active time period data with a content element, as used in an example embodiment.

FIG. 12 is a diagrammatic representation of a system for authoring electronic content in which content elements associated with the electronic content may be associated with active time period data, as used in an example embodiment.

FIG. 13 is a flowchart illustrating a method for authoring electronic content in which a content element associated with the electronic content may be associated with active time period data, as used in an example embodiment.

FIG. 14 is a flowchart illustrating a method for authoring electronic content, such as, for example, an electronic document, in which a content element may be associated with the electronic content and with active time period data, as used in an example embodiment.

FIG. 15 is a flowchart illustrating a method for authoring electronic content, such as, for example, an electronic document, in which a content element may be associated with active time period data by the use of delimiting data element, as used in an example embodiment.

FIG. 16 is a flowchart illustrating a method for authoring electronic content, such as, for example, an electronic document, in which a content element may be associated with active time period data encapsulated in an optional content group, by the use of delimiting data element, as used in an example embodiment.

FIG. 17 is a flowchart illustrating a method for authoring electronic content, such as, for example, an electronic document, in which a content element may be associated with active time period data encapsulated in an optional content group, by the use of delimiting data element, in which the electronic document is stored in a form such as that represented in FIG. 10 or FIG. 11, as used in an example embodiment.

FIG. 18 is a diagrammatic representation of a data structure that may be used by an authoring system to allow content elements associated with electronic content to be associated with active time period data encapsulated in optional content groups using delimiting data element tags, as used in an example embodiment.

FIG. 19 is a diagrammatic representation of a system for facilitating reading, carrying out rendering, or otherwise making accessible electronic content having associated content elements, where the content elements are associated with active time period data, as used in an example embodiment.

FIG. 20 is a flowchart illustrating a method for rendering or otherwise making accessible electronic content having associated content elements, where the content elements are associated with active time period data, as used in an example embodiment.

FIG. 21 is a flowchart illustrating a method for rendering or otherwise making accessible an electronic document having associated content elements, where the content elements are associated with active time period data and rendered according to a current time period, as used in an example embodiment.

FIG. 22 is a flowchart illustrating a method for rendering or otherwise making accessible an electronic document having associated content elements, where the content elements are associated with active time period data and rendered according to a current time period, using active time period data and delimiting tags, as used in an example embodiment.

FIG. 23 is a further flowchart illustrating a method for rendering or otherwise making accessible a multi-file, page-organized electronic document having associated content elements, where the content elements are associated with active time period data via optional content groups, as used in an example embodiment; and

FIG. 24 shows a diagrammatic representation of machine in the example form of a computer system within which a set of instructions, for causing the machine to perform any one or more of the methodologies discussed herein, may be executed.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

Embodiments may, for example, be implemented as a stand-alone application (e.g., without any network capabilities), a client-server application or a peer-to-peer (or distributed) application. Embodiments may, for example, be deployed by Software-as-a-Service (SaaS), Application Service Provider (ASP), or utility computing providers, in addition to being sold or licensed via traditional channels.

Introduction

For the purposes of this specification, the term “electronic content” shall be taken to include any digital data that may be presented to a consumer (e.g., visually or audibly presented) and may include electronic document, page-descriptive electronic content such as a page-descriptive electronic document, media stream, web page, hypertext document, image, digital video, digital audio, an animation, merely for example. A “content element” shall include any part or share of electronic content that is defined or discernable as a part or share. For example, a content element may be automatically discerned from a characteristic of the content element itself (e.g., a paragraph of an electronic document) or may be manually defined by a user (e.g., a user-selected collection of words in an electronic document, a user-selected portion of a digital image). Examples of content elements include portions of a page-descriptive document or other electronic document, such as, for example, pieces of electronic text or other material within the electronic document, portions of media streams such as sections of digital video or frames or sets of frames of digital video or digital audio, segments or frames of animations, and various elements presentable or accessible by users within electronic content, and the like. Content elements may include empty content, for example an electronic document may include a blank page; the content of the blank page, namely any data indicating its blankness, may in some embodiments be considered as a content element, namely an empty content element. Content elements may include format data such as, for example, position information describing the placement of other content element(s), or information specifying colors or fonts to be used in rendering other content element(s).

For the purposes of this specification, a content item may be “associated” with electronic content. Examples of such association include inclusion within a file or other data structure containing the electronic content, the presence of a direct or indirect reference to the content element within electronic content, or the presence of a data structure, file, or other mechanism by which a content element is associated with electronic content. The association of a content element with electronic content does not necessarily require that when the electronic content is presented (or otherwise made accessible to a user or as input to a machine), that the content element is, in the course of presentation or access, also presented or made accessible.

When a content element is “included” by or in electronic content, the content element may be presented or made accessible in the course of presenting or making accessible the electronic content with which the content element is associated. Similarly, when a content element is “active”, the content element may be presented or made accessible in the course of presenting or making accessible the electronic content with which the content element is associated.

In considering the association between electronic content and an associated content element, the term “literally included” may be used. In this specification, electronic content may, for example, literally include a content item if the data structure that contains the data that largely describes the electronic content includes the data that largely describe the content element. In some embodiments, a content element may be associated with electronic by reference, wherein the data that describes the content element is not directly contained within or integral with the data that describes the electronic content with which the element is associated.

It will be appreciated that a content element that is literally included within electronic content may, in some examples, not be included within that electronic content. By way of a specific example, consider an electronic content such as a piece of digital video having a number of separate video segments that may be considered content elements. If the various video segments are all stored in, for example, the same file or other data structure, the video segments may be considered to be “literally included” in the digital video as a whole. However, one or more of these video segments might not be “included” in the digital video as a whole, for example by being skipped during the playing of the digital video as a whole by a user, or being processed or analyzed by a video processing program. By way of a further specific example, consider such an electronic content as a multi-layer technical drawing as might be produced by a computer-aided design (CAD) system, in which each layer is considered as a content element. Such a drawing may literally include all of the layers by storing all the layers in the same file as the drawing as a whole, but some layers may not be included in the drawing, if for example, some layers have been marked by a user as hidden, or marked as only visible or otherwise accessible during certain time periods.

For the purposes of this specification, the term “rendering” includes presenting or making accessible electronic content or content elements to be perceived, viewed, or otherwise experienced by a user, or be made available for further processing, such as, for example, searching, digesting, printing, analyzing, distilling, or transforming by computational processes that may not include processing the intrinsic data structure describing the electronic content or content element. Whether a content element associated with an electronic content is included in the rendering of the electronic content may, by default, be determined by whether or not the content element is active.

For the purposes of this specification, an “optional content group” may be, for example, a data construct that delineates or identifies content elements associated with electronic content and specifies circumstances under which those content elements may be considered active or included in the electronic content. For example, the circumstances can include the situation in which the current time period overlaps the active time period that is specified in active time period data associated with an optional content group. Optional content groups may be represented or implemented in memory or on a machine-readable medium by optional content group objects.

For the purposes of this specification, a “module” includes an identifiable portion of code or data or computational object to achieve a particular function, operation, processing, or procedure.

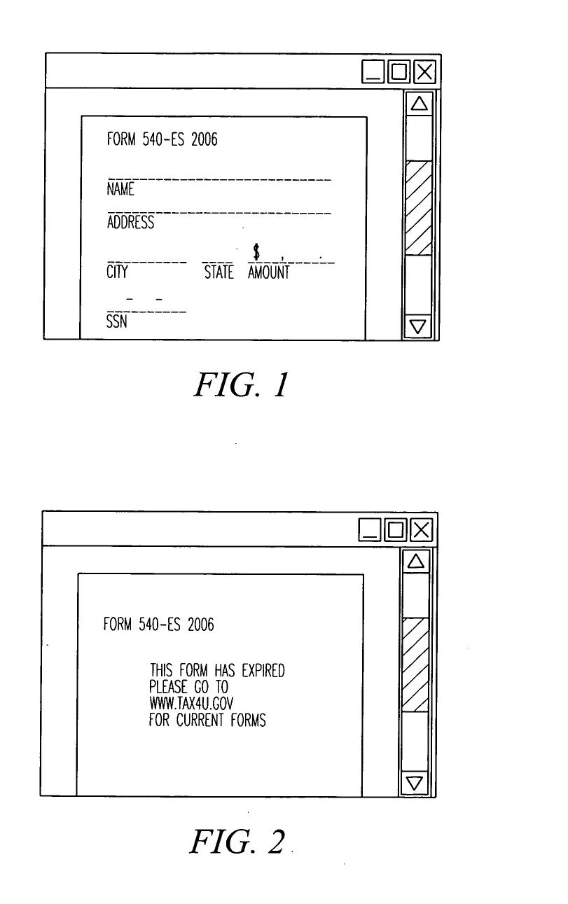

FIG. 1 and FIG. 2 are diagrammatic representations of windows (or user interface components) on a computer screen showing a view or rendering of an electronic content associated with at least two content elements during a first time period and second time period, according to an example embodiment. A rendering of electronic content is, in this example, an electronic document providing an estimated tax form. FIG. 1 and FIG. 2 may be based on the same electronic content, and may in fact be created from the same underlying data structure. For example, they may both be created by a reading application running on a computer and loading electronic content from the same file or group of files.

It will be appreciated that the electronic document rendered in FIG. 1 and FIG. 2, has associated with it (among other possible content elements) two content elements. A first content element associated with the electronic document may be the form of FIG. 1, including spaces for name, amount, etc. A second content element associated with the electronic document may be the text in FIG. 2, indicating that the document has expired. It will be appreciated that a reading application, given an electronic document to which both content elements are associated, may include one or the other content elements in a rendering, depending for example on the date (e.g., during year 2006 or otherwise) that such a reading application is invoked to view or render the electronic document.

Electronic content may be associated with one or more content elements. In addition, each such content element may be associated with active time period data, the active time period data specifying a time interval or period during which a content element may be considered active, or included within the electronic content to which it is associated.

Such active time period data may specify an open or closed ended time period, and may be of varying granularity. For example, some active time period data may specify that a content element be active starting at a particular hour and minute and be active thenceforth. In some examples, active time period data may specify a discontinuous time period, such as, for example, a time period that includes only the Saturdays of a particular month and year. In other examples, the active time period data may be to the granularity of days or months. In some embodiments, the active time period data may specify that a content element be active in absolute terms, while in other embodiments the active time period data may specify a content element's active time period relative to another date or time associated with the electronic content, such as a file creation date. The active time period data may be composed and defined by a combination, such as by union or intersection of various time periods. A single piece of active time period data may also be associated with more than one content element. Finally, in some embodiments, several instances of active time period data may be associated with a single content element. In that case, a rendering or viewing application may, at a particular time, initiate a process to determine how to resolve the situation, for example by taking the union or intersection of the various associated active time period data or some other process.

In order for active time period data to be associated with a content element, association data may be used. In some embodiments, association data may be stored with the content element, while in other embodiments it may be stored elsewhere. The association data may be in the form of delimiting data, setting off a content element from other content. This delimiting data may reference or otherwise serve to associate the active time period data to the content element it sets off. In some other embodiments, association data may in some other way describe the content element to which the active time period data applies, for example, by including a listing of frame numbers of a video stream.

In order for a rendering or viewing application to create a rendering of electronic content to which is associated content elements (that are themselves associated with active time period elements), the application may need to have access to some indication of the current time. In some embodiments, such an application may be running on a computer having a real-time clock, and at the commencement of the rendering operation, obtain a current time from the real-time clock. In other embodiments, the application may obtain a current time from a network, such as from a web site. In some further embodiments, the application may allow a user to input a current time. For example, a user may input a current time when the machine carrying out the rendering operation does not have a clock or has a clock that is not set properly. Another example of a situation when a user may input a current time may occur when a user needs, or wants, to override a current time obtained from another source or to force an arbitrary time to be taken as the current time.

It will be appreciated that while a current time may be an instantaneous point, in real-world applications, the notion of a current time may need to reflect some inaccuracy. For the purposes of this specification “current time period data” shall mean data specifying a period of time that is sufficiently precise, for a particular rendering or viewing application, so as to be considered the current moment in time. For example, a current time on a very accurate computer clock may be considered a current time period specifying a particular microsecond, while in other contexts and applications a current time may be represented by a current time period data specifying a particular six-hour period. Another example is that of a current time period data that specifies a current date, which may be taken to include the entire hours encompassed within the current date. In some embodiments, a render or viewing application may render a particular content element if the active time period data associated with that element overlaps the current time period data that the application obtains from a system clock, user input, or other source.

Finally, in some embodiments, a rendering or viewing application may by default render only content elements that are active at the current time, but may include an option to allow a user or other consumer of the rendering to force the inclusion of content elements that are not active according to the current time.

Example Data Structures

The following sections describe various example data structures that may be used, in some embodiments, to facilitate the storage of electronic content associated with content elements that are themselves associated with active time period data. These example data structures may be stored on computer-readable media, or maintained in, for example, the main or secondary memory of a computer.

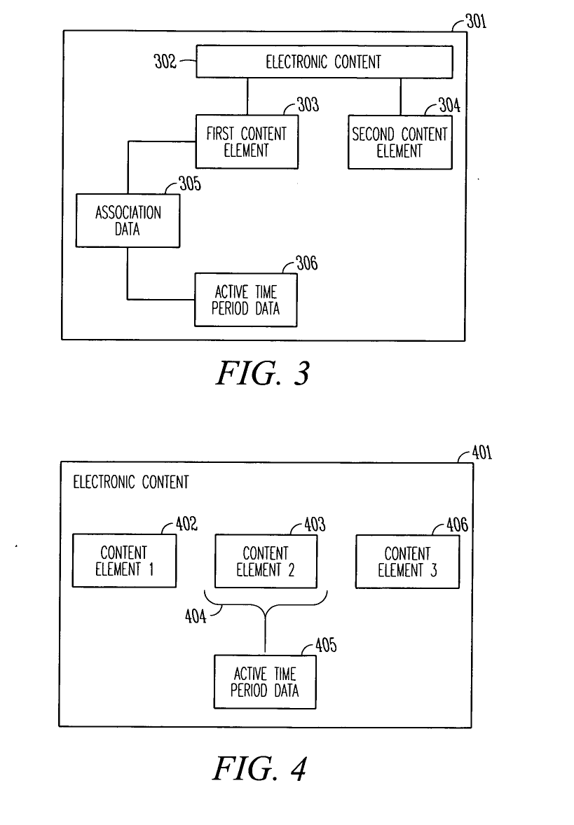

A diagrammatic example illustrating one such example data structure as shown in FIG. 3. In FIG. 3 a data structure 301 is shown as it may be stored on a computer-readable medium or the like. The data structure 301 may include a number of components, such as electronic content 302 that may include formatting information for use by a rendering application taking the data structure 301 as input, as well as a first content element 303 and a second content element 304. In FIG. 3, a first content element 303 is associated with association data 305, which acts to associate the first content element 303 with active time period data 306. It will be noted that a second content element 304 is not associated with particular active time period data; in some embodiments this condition may cause the second content element to be rendered regardless of the current time period data used by the rendering application while in other embodiments, the lack of associated active time period data may suppress the rendering of the second content element. A single data structure such as that illustrated at 301 may further include numerous content elements and content elements may be nested with a particular content element serving as electronic content associated with another content element.

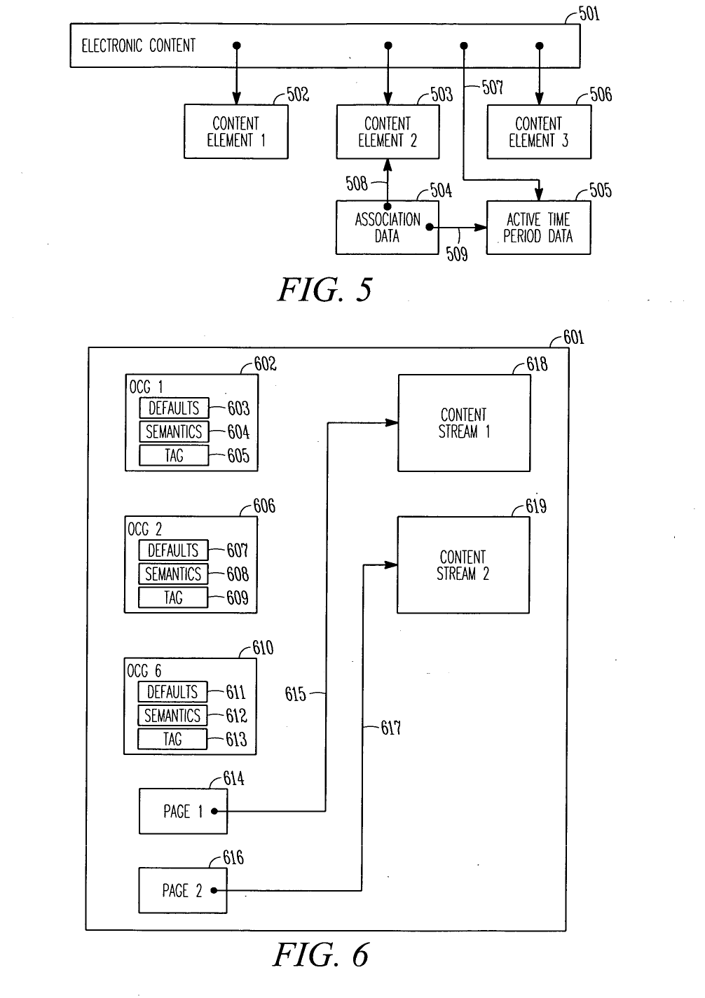

FIG. 4 and FIG. 5 are diagrammatic representations of data structures including electronic content that may be stored on computer-readable media or as may serve as input to various rendering or viewing applications and correspondingly as output from various authoring applications.

FIG. 4 illustrates example electronic content 401 and three content elements 402, 403, and 406, where the content elements are literally included in the electronic content 401. The electronic content 401 also includes active time period data 405, which is shown associated to content element 403 by association data 404, the association being depicted as a bracket. In an embodiment such as that shown in FIG. 4, active time period data 405 may also be literally included in the electronic content. Association data 404, as suggested by the bracketlike glyph, may in some embodiments, be of a delimiting nature, setting off or separating its associated content element 403 from other content elements or from the electronic content 401 as a whole.

FIG. 5, by contrast, shows a data structure where content elements are not literally included in electronic content (e.g., the main page of a web site, the main sequence of a digital video, etc) but may, for example, be placed in separate parts of a file from one another and from other data elements, or in other embodiments even placed in separate files in a file system. In FIG. 5, electronic content 501 is shown referencing three associated content elements 502, 503, and 506. Content element 503 is associated by association data 504 with active time period data 505. As illustrated in FIG. 5, this may be accomplished by references 508 and 509. In some embodiments, the electronic content 501 may also reference active time period data 505 via reference 507. The references 508, 509 and 507 may be bidirectional and may represent locations or symbolic names within a single file, or may in other embodiments, represent file names, file pointer locations, or combinations thereof. Such references provide data to allow rendering or viewing applications to traverse the data structure to assist in determining which content elements should be displayed in response to particular current time period data.

FIG. 6 shows a diagrammatic representation of an example file structure where content elements are literally included within electronic content along with various other data structures, according to an example embodiment. In FIG. 6, the overall data structure is represented by a rectangle 601 containing various data objects. The data structure of FIG. 6 may be used, for example, in representing electronic documents, such as page-descriptive documents in which pages play a semantic role.

Within the data structure of FIG. 6, page objects 614 and 616 are illustrated, corresponding to two pages present, for example, in a rendering of the electronic content represented in FIG. 6 rendered onto a screen or printed on a printer. These two page objects 614 and 616 may include references 615 and 617, respectively, allowing an association to content streams 618 and 619, respectively via references 615 and 617, respectively; although each of pages 614 and 616 is shown referencing a single content stream, in general each page may reference as many content streams as desired by the author of the electronic document, and a single content stream may be referenced by multiple pages. References 615 and 617 may, in some embodiments, include data structures providing a location of the beginning of the content streams, or in some other embodiments providing a symbolic name of a content stream, or other identifying data. Content streams may, for example, be a type of data structure or data object defining, including, or referencing one or more content elements and may include glyphs, formatting information, placement information, or other information used to create rendering of the content elements. In embodiments, such as the data structure of FIG. 6, a content element may be associated with the electronic content a whole by virtue of being a portion of a content stream (which is in turn a portion of the electronic content as a whole)

Electronic content data structures such as, for example, the type illustrated in FIG. 6, may include data objects in the form of optional content groups, represented at 602, 606, and 610. These optional content groups may provide data to facilitate association between content elements and active time period data. The association may be facilitated by providing semantics data (illustrated at 604, 608 and 612), that includes active time period data, and by providing a symbolic tag (illustrated at 605, 609, and 613). The inclusion of the symbolic tag provided by an optional content group within paired start/end delimiters, where the delimiters define a content element within a content stream, may serve to associate that content element with active time period data located in the semantics section of the optional content group's data. It will be appreciated that in this way, numerous content elements may be defined by a user (such as, for example, via an authoring application) as being associated with particular active time period data. It will be further appreciated that delimiter pairs may nest, defining content elements within content streams, with varying rendering semantics. Finally, content elements within a content stream not specifically delimited may be rendered independent of current time period data upon the rendering of the referencing page.

A final data item within optional content group data is the defaults data (illustrated at 603, 607 and 611). In some embodiments, the defaults data may include a flag to indicate whether the optional content group is enabled or disabled. Optional content groups may also include other information, such as a symbolic name and the like.

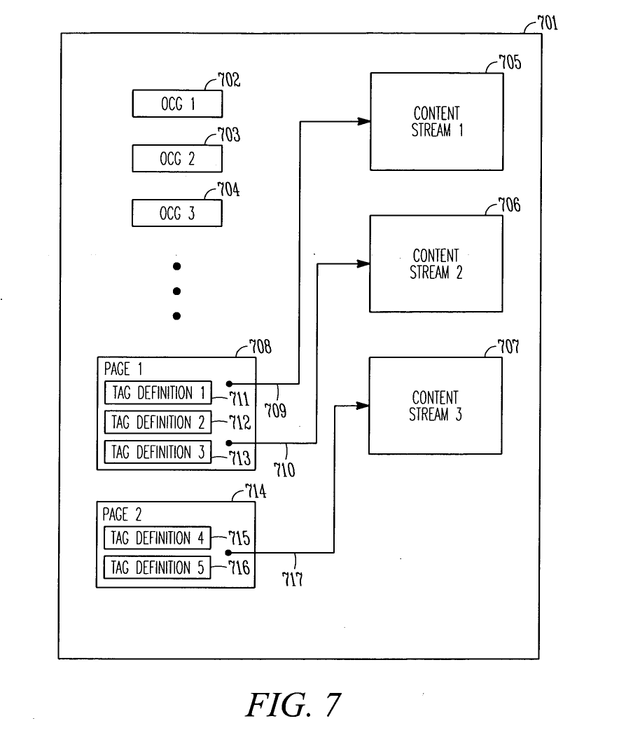

FIG. 7 shows a diagrammatic representation of a further example file structure, designated generally as 701, where content elements are literally included within electronic content along with various other data structures, according to an example embodiment. FIG. 7 is similar to FIG. 6 in that it includes page objects 708 and 714, as well as optional content groups 702, 703, and 704 and content streams 705, 706, and 707, all associated by being literally included in the overall electronic content 701. Pages may reference various content streams that may be rendered in the renderings of those pages. For example, in FIG. 7, page object 708 references, via reference data 709 and 710, content streams 705 and 706, respectively, while page object 714 references, via reference data 717, content stream 707.

The role of the optional content groups 702, 703 and 704 in an embodiment such as that illustrated in FIG. 7 is similar to the role of optional content groups 602, 606, and 610. However, in this embodiment, symbolic tags used to identify content elements between delimiting start/end data within content streams may not be stored within optional content data structures. In a data structure such as illustrated in FIG. 7, tag definition data (such as that illustrated at 711-713 and 715-716) may be included in page object data. Tag definition data may include a symbolic tag and an identifier for an optional content group. Where a content element in a content stream is delimited by a start/end pair that includes the symbolic tag, that content element may be associated with active time period data stored in the optional content group. The optional content group is in turn identified by the tag definition data with that symbolic tag in the page object that references that content stream.

By way of specific example, a content stream 707 may include a particular content element, defining, for example, a paragraph of text. Further, the page object 714 may for example include tag definition data 715 that includes the symbolic tag “tagxx” and identifies optional content group 704. Finally the optional content group may include active time period data describing the interval of Jul. 12, 2006 through Jul. 14, 2006 in its semantics data and is enabled. In this example, a pair of instances of delimiting start/end data including the symbolic tag “tagxx” surrounding the paragraph of text may indicate that the active time period data associated with the paragraph of text includes the interval Jul. 12, 2006 through Jul. 14, 2006.

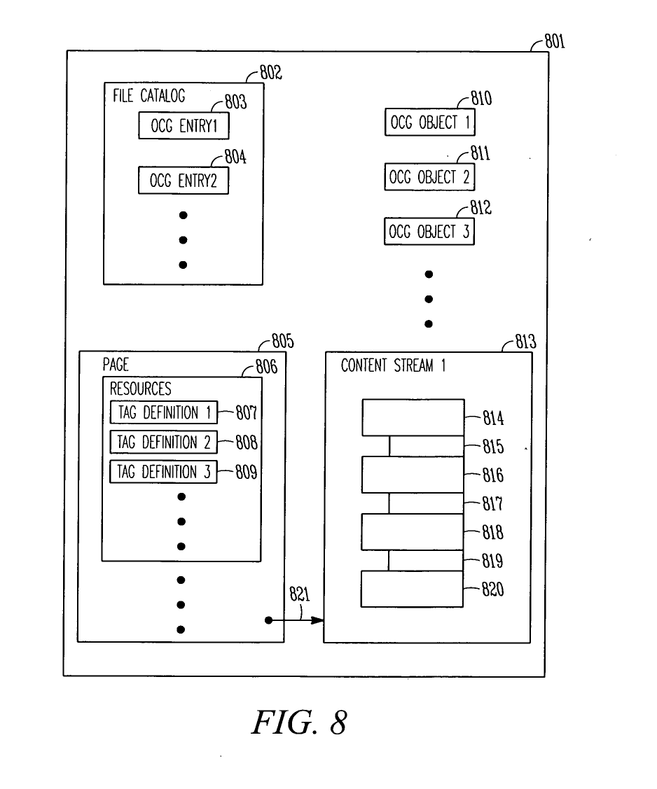

FIG. 8 diagrammatically represents yet another data structure, designated generally as 801, that may be used to store or represent a page-organized electronic document. In FIG. 8, a page object 805 references (by reference data 821) a content stream 813, the content elements of which may be rendered onto a rendition of the page 805. The content stream 813 may include a number of content elements 814-820, of which several are identified and delimited by start/end data; these distinguished content elements are indicated by the inset content element glyphs 815, 817, and 819. Page object 805 may literally include (or in some embodiments be associated with) a number of resources objects, such as a resources object 806 that provide various resources (such as font definitions, color definitions and other resources) for use by a page. For example, the resources object 806 includes tag definition data that may be used for associating content elements (such as at 815, 817 or 819) within the content stream 813 with optional content groups such as at 810, 811, or 812 in a similar manner as described above with respect to FIG. 7.

The data structure illustrated in FIG. 8 differs from that of FIG. 7 by also having a file catalog 802 to serve as a root object or table of contents for the data structure. This catalog may have a number of entries corresponding to the various data objects contained in or associated with the data structure, including entries 803 and 804 for the optional content group objects. These entries, for example, may include data indicating whether the corresponding optional content group is enabled, or might even contain active time period data applicable to a corresponding optional content group.

As mentioned above, the data structures of FIGS. 6-8 describe example arrangements for using association data to associate content elements with active time period data. It will be appreciated that while these data structures have been described in terms of their use for describing page-organized electronic documents, similar and different data structures, embodying similar principles of organization may be used for describing a wide range of electronic content having time-based optional portions. While the data structures of FIGS. 6-8 have been primarily described as residing within a single file, the various data objects may also be divided among multiple files.

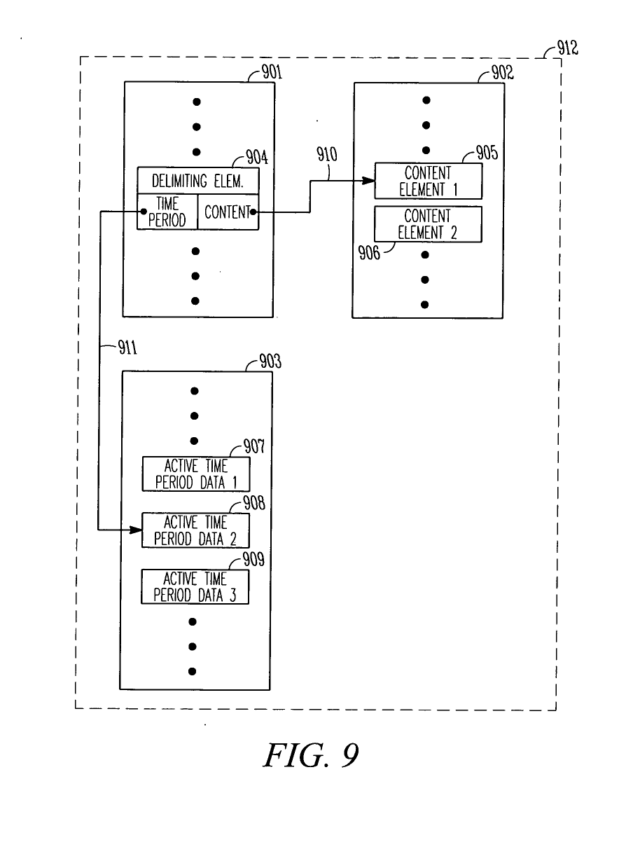

FIG. 9 diagrammatically represents a yet further data structure, designated generally as 912, for storing electronic content that is associated with content elements, where the content elements are associated with active time period data. The data structure 912 includes three distinct components, which may be files or other distinct storage artifacts. A first component 903 may have one or more identifiable instances of active time period data 907-909. A second component 902 may have one or more identifiable content elements 905 and 906. A third component 901 may have one or more delimiting elements serving as association data to associate content elements (such as 905 or 906) with active time period data (such as 907, 908, or 909). A delimiting data element 904 may include a reference 910 to the associated content element and a reference 911 to the associated active time period data. In a data structure embodied as three separate files 901, 902, and 903, these references 910 and 911 may include a file name and a file position within the named file to allow location of their targets. In some other embodiments, the file 901 may include the names of the other files in the data structure with the references 910 and 911 needing only to specify a file position. In some embodiments, the references 910 and 911 may need to merely specify a symbolic name for the data objects they reference, with a file indexing mechanism being present in files 902 and 903 to provide translation from the symbolic name to a file position. It will be appreciated that numerous other techniques are available for facilitating inter-file or inter-component referencing between association data, such as a delimiting data element 904 and active time period data such as 907-909 and content elements such as 905 and 906. In some embodiments, the components 901, 902, and 903 illustrated in FIG. 9 may be included within a single file, with component 901 possibly serving as a file contents table. In such embodiments, delimiting data element 904 may be represented as a file contents table entry.

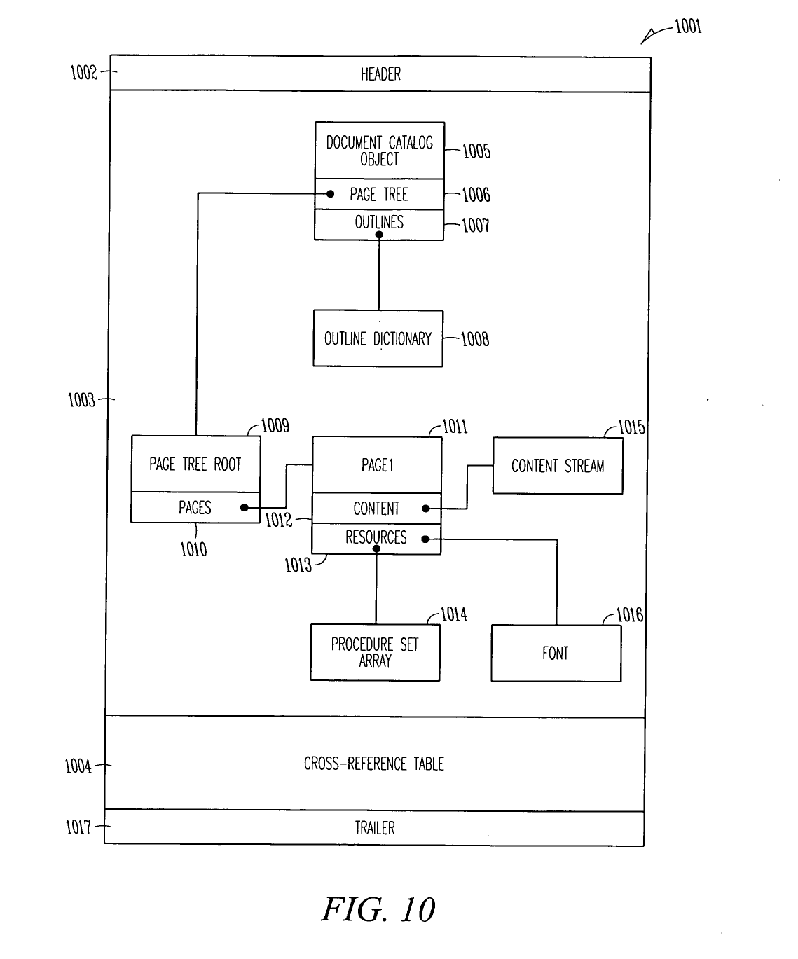

FIG. 10 shows a diagrammatic representation of a data structure, designated generally as 1001, that may be stored as a file. This type of data structure may be used to store page-descriptive electronic documents, such as ADOBE® Portable Document Format (PDF) documents. This type of format is designed to be especially easy and robust to update by using an authoring application and it will be appreciated that it bears similarity to the data structures illustrated in FIGS. 6-8.

The data structure 1001 which may be implemented as a sequentially organized file has a header section 1002 that may include format or version information, a main data object section 1003 that may contain various data objects, a cross-reference table 1004 that may contain a directory of the file and include, for example, location information for the various data objects, and a trailer 1017 that may include such information as the location of the cross-reference table 1004, identification of the root data object (such as, for example, document catalog object 1005), or the number of data objects in the file.

The main data object section 1003 may contain a number of data objects, which may be literally included within the main data object section 1003. A document catalog object 1005 may serve as the main root object of the various data objects. The document object catalog 1005 may have data 1006 referencing a page tree root object 1009 and may also have data 1007 referencing an outline dictionary. The page tree root object 1009 may have a list 1010 of references to page objects, such as page 1011. Page objects, such as page 1011 may have content data 1012 referencing content stream objects, such as content stream object 1015, associated with the page and renderable in conjunction with a rendering of that page object. A page object such as 1011 may also have a list of resource references 1013 referencing resources such as font data 1016 or a procedure set array 1014. A procedure set array 1014 may be needed to specify the procedures needed by an output device to interpret the data describing content elements of a content stream for rendering, such as, for example printing. An outline dictionary object, indicated by 1008, may providing user-oriented outline data for the electronic document, and may provide references from outline nodes to spatial locations on renderings of the various pages.

References from data objects (e.g., 1011, 1005, etc) to other data objects within the main data object section 1003 may be given by mentioning a symbolic identifier of the data object; application programs that access or manipulate files structured as in FIG. 10 may use the cross-reference table to provide mapping from symbolic identifiers to data object location.

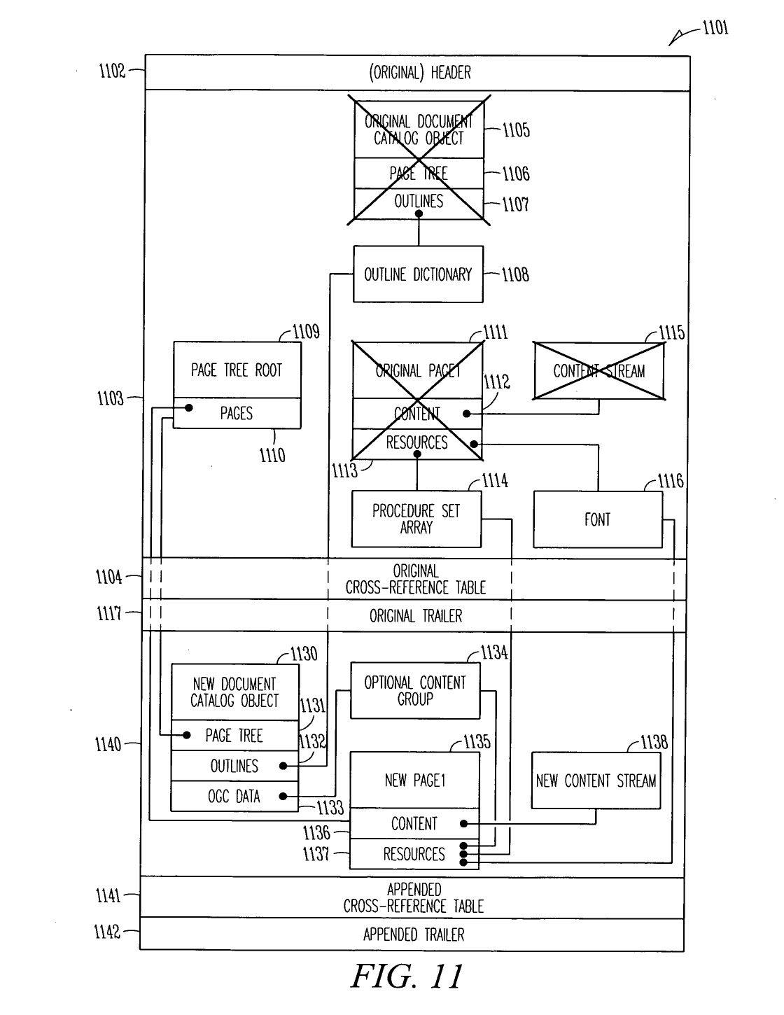

FIG. 11 shows a diagrammatic representation of a data structure 1101, such as a file, corresponding to FIG. 10, as it may be structured after being updated by, for example, an authoring tool, to include active time period data associated with content elements within a content stream object(s).

To make the updating robust, a file as illustrated in FIG. 10 may not need to be replaced with a new file that includes the time-based associations, but can rather have additional data appended to the original file. FIG. 11 illustrates how this may be done for example.

It will be observed, by comparison to the original file structure of FIG. 10, that the file structure of FIG. 11 has a second main data object section 1140, an appended cross-reference table 1141 that semantically replaces the original cross-reference table 1104, and provides data constituting an updating of the original cross-reference table 1104. Finally, it will be observed that an appended trailer 1142 is present and may serve to semantically replace the original trailer 1117. Further, a number of data objects may be added to the appended second main data object section 1140, including an optional content group object 1134, as well as a new document catalog object 1130, a new page object 1135, and a new content stream object 1138. These new objects semantically replace the original objects 1105, 1111, and 1115, respectively. The original objects, however, may physically remain in the file, as indicated in FIG. 11 by being present yet defaced by cross-out glyphs.

The new document catalog object 1130 may have references to the original page tree object 1109 and the original outline dictionary 1108, and in addition may include optional content data 1133 and a reference to the newly-appended optional content group object 1134. The optional content data 1133 may include various details about optional content groups within the file, such as which optional content groups are enabled. The resources data 1137 of the new page object 1135 may have references to the original procedure set array 1114 and the original font data object 1116 within its resources data 1137. In addition, the resources data 1137 of the new page object 1135 may reference the newly-appended optional content group object 1134 and the content data 1136 may reference the new content stream object 1138.

To associate active time period data with a content element described or encapsulated within the new content stream object 1138, the active time period data may be stored or otherwise accessible within the new optional content group object 1134, and a symbolic tag associated with the active time period data stored within the page object 1135, or in some embodiments, within the new optional content group object 1134. So defined and stored, the symbolic tag may be used with delimiting data elements, such as a pair of start/end delimiters, to set off or identify a content element within the new content stream object 1138. In that way the content element becomes associated with the active time period data and susceptible to being included in the electronic document represented by the data structure 1101 (e.g., stored in a file or other computer-readable medium) when, for example, the active time period overlaps a current time period. In some embodiments, the tag may not be used in the context of a delimiting data but may be associated with some other indicator of a content element, such as a symbolic name of the content element, or an annotation to a file contents table or table or other data structure describing the contents of a content stream such as stored in new content stream object 1138.

While the foregoing paragraphs and associated present data structures and formats with reference to an embodiment in which electronic content is an electronic document, and content elements are sections of that document, it will be appreciated that similar and dissimilar data structures and file formats or other representations may be used for all kinds of electronic content, in additional to electronic documents, and that the application of similar techniques for associating content elements with active time period data will be apparent for various electronic content types.

Example Authoring Methods and Systems

In the foregoing section, various data structures and file formats are described by which an electronic content may be represented in a compute memory or other computer-readable medium. In this section various methods and systems for authoring electronic content are presented.

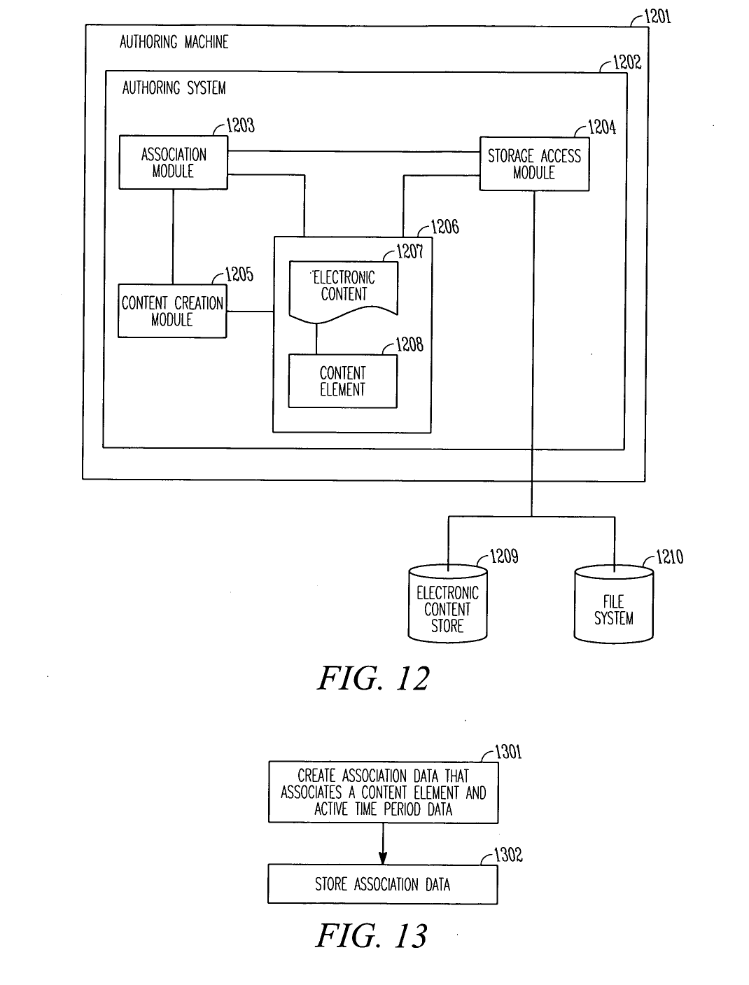

FIG. 12 shows a diagrammatic representation of a system for use in authoring electronic content that may be associated with one or more content elements, and where the content elements may be associated with active time period(s).

An authoring system 1202 may run on an authoring machine 1201, such as a computer or other equipment. The authoring system 1202 may include an association module 1203, a storage access module 1204, and, in some embodiments, a content creation module 1205. A machine-readable medium such as, for example, a memory 1206 may be accessible to the various modules 1203, 1204, and 1205. The memory 1206 may initially contain machine-readable data representing electronic content 1207 to which may be associated one or more content elements, for example content element 1208. This association may be by literal inclusion, by reference or by other technique. The system shown in the embodiment of FIG. 12 may also include an electronic content store 1209 and a file system 1210.

An association module 1203 may serve to create association data that associates content element 1208 with active time period data, the active time period data specifying a time period during which an association between electronic content 1207 and the content element 1208 is active. A storage access module 1204 may serve to access the content element 1208, in some embodiments making it available to the association module 1203, and in some embodiments by retrieving it from and electronic content store 1209 or from a file system 1210 or other storage device. The storage access module 1204 may also store the association data and the active time period data. In embodiments in which an authoring system 1202 includes a content creation module 1205, the content creation module 1205 may create the content element 1207 and/or the electronic content 1208, and may store them in the memory 1206, making it available for the storage access module 1204 to store one or both into an electronic content store 1209 or a file system 1210; in some embodiments an electronic content store 1209 may in fact be partially or fully stored in the file system 1210. In some embodiments, the association data, active time period data, content element 1208, and electronic content 1207 may all be stored in a single file by the storage access module 1204, while in other embodiments they may be stored into two or more separate files. The association module 1203 may, in some embodiments, encapsulate or insert the association data into or within the electronic content 1207. Association module 1203 may be capable of forming multiple associations between various content elements, such as content element 1208, and electronic content 1207.

FIG. 13 is a flowchart illustrating a method for authoring electronic content in which a content element associated with the electronic content may be associated with active time period data, as used in an example embodiment. At 1301, the association module 1203 may create association data that associates a content element and active time period data. At 1302, the association data is stored, for example by the storage access module 1204. The method of FIG. 13 may include other procedures (not shown) such as storing the active time period data, creating the content element, associating an existing content element to electronic content, storing the content element, encapsulating association data into the electronic content, encapsulating the active time period data into electronic content, or repeating any of these procedures multiple times with respect to various content elements, association data, or active time period data, or other procedures. It will be appreciated that these procedures may be applied to various types on electronic content.

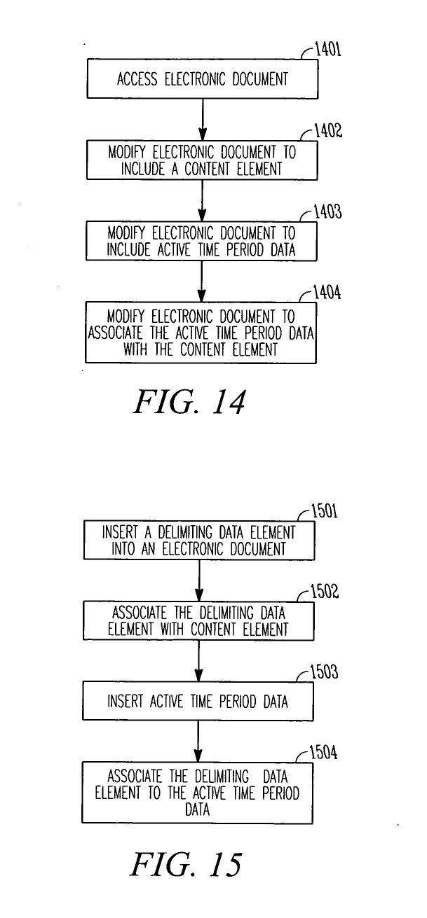

FIG. 14 is a flowchart illustrating an example method for authoring electronic content, such as, for example, an electronic document, in which a content element may be associated with the electronic content and with active time period data. In some embodiments, the procedures illustrated in FIG. 14 may be carried out by a system such as that shown in FIG. 12. At 1401, electronic content, such as, for example, an electronic document is accessed by the storage access module 1204, and made available to, for example, association module 1203, by storing the electronic content in a memory 1206 or other computer-readable medium accessible to an association module 1203. At 1402, the electronic content, such as an electronic document, is modified by the content creation module 1205 to literally include a content element, thereby associating the content element with the electronic content. At 1403, the electronic content, such as, for example an electronic document, is modified to literally include active time period data, and at 1404, the electronic content is modified to associate the content element with the active time period data. The modifications at 1403 and 1404 may take place in a variety of ways, such as by creating a new version of the electronic content, appending data objects and associated cross-reference data to an existing representation of the electronic content, or even by modifying electronic content located in a file system 1210 or electronic content store 1209, with the collaboration of a storage access module such as that illustrated at 1204. In some embodiments the procedures at 1403 and 1404 may be carried out primarily or completely by the association module 1203.

FIG. 15 is a flowchart illustrating a method for authoring electronic content, such as, for example, an electronic document, in which a content element may be associated with active time period data by the use of delimiting data element, as used in an example embodiment. FIG. 15 illustrates an alternative ordering of a procedure for associating active time period data with a content element, which may, in some embodiments, be carried out by an association module, such as that shown at 1203.

At 1501, a delimiting data element may be inserted into an electronic document or other electronic content. This delimiting data element is to be used to delimit or otherwise identify a content element to which active time period data is to be associated. At 1502, the delimiting data element is associated with a content element. This association may be carried out in various ways, such as by inserting a newly created content element between the parts of the delimiting data element (e.g., a start/end par of delimiters), moving the electronic content from another location, such as another part of the electronic document into a location sequentially between start/end delimiting data, or by flagging electronic content to semantically associate it with the delimiting data element. For example, if the authoring system 1202 includes a graphical user interface (GUI) that shows the electronic content, the user may insert a GUI item representing the delimiting data element in the form of a start/end pair, and then select a content element within the GUI and “drag and drop” it between the start/end pair. At 1503, active time period data is inserted or otherwise associated with the electronic document, which may be done, for example, by entry via a GUI provided by an authoring system 1202. Finally, at 1504, the delimiting data element is associated with the active time period data, thereby effecting an association between the active time period data and the content element. In some embodiments, the underlying data structures that are modified in the course of these operations may be of a type illustrated in FIGS. 4-11.

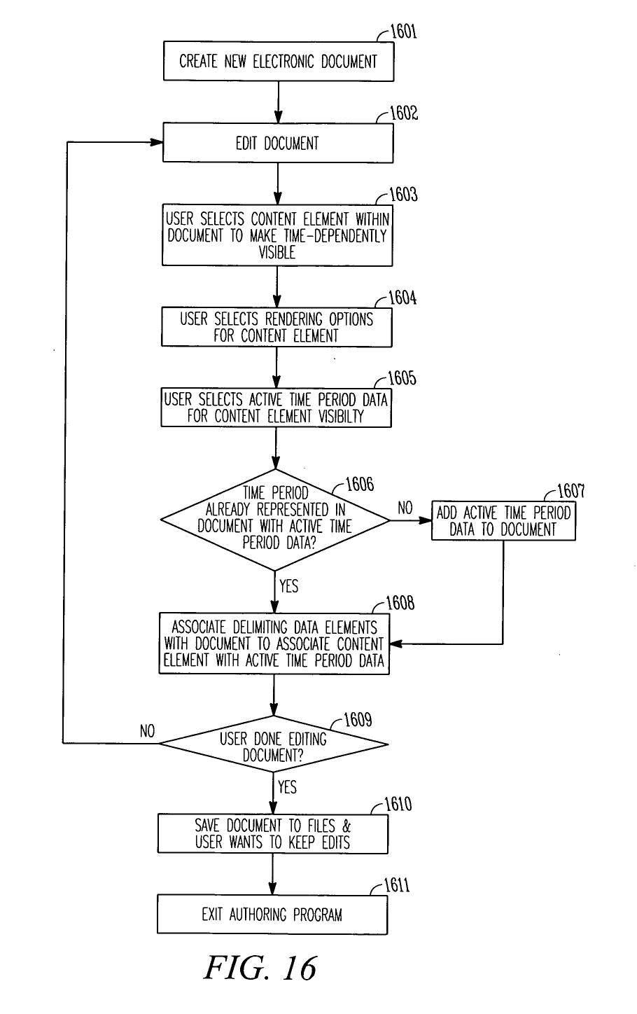

FIG. 16 is a flowchart illustrating a method for authoring electronic content, such as, for example, an electronic document, in which a content element may be associated with active time period data encapsulated in an optional content group, by the use of delimiting data element.

At 1601, a new electronic content, such as an electronic document, is created. This creation may be done, for example, by a content creation module 1205. The creation of the new electronic document may include creating various content elements associated with the electronic document and other authoring tasks and may be facilitated by a graphical user interface (GUI). For example, the creating of a new electronic document may include entering various pieces of text, selecting fonts with which pieces of text are to be rendered, creating animations or digital video, associating the animations or digital video with the electronic document, and other operations. At 1602, the electronic document may be edited, a process that may overlap with the content element creation and inserting described above with respect to the procedure at 1601. At 1603, the user may select a content element (associated with the electronic document) to make time-dependently visible or includable within the electronic document, or within a rendering of the electronic document, or to make that content element's association with the electronic document active for a particular active time period. This selection may be effected by highlighting the item in a GUI representation of the electronic document or by some other technique. At 1604, the user may select rendering options for the content element, such as font color for text.

At 1605, the user may select an active time period to associate with the content element, such as to determine when it is to be visible in renderings of the associated electronic document. This may be done, for example, by allowing the user to enter a time period in a dialog box in a GUI, or to select from, or add to, a list of time periods already associated with the electronic document. At 1606, a determination may be made whether the user-entered time period is already represented in data associated with the electronic document. If it is not, active time period data corresponding to the user-entered period is added or associated with the electronic document at 1607. In either situation, processing may continue to 1608. At 1608, delimiting data elements are associated with the selected content element and those delimiting data elements are also associated with the active time period data corresponding to the time period that was selected by the user at 1605. At 1609, it may be determined whether the user is finished editing the electronic document; if not, the user may continue editing at 1602. On the other hand, if the user is finished editing the electronic document and wishes to keep the edited active time period data associations and the like, the electronic document may be saved, along with its associated content elements, delimiting data elements, active time period data, etc to one or more files or other suitable data structures. These files may reside in a file system such as that of 1210 or an electronic content store such as that of 1209. Finally, the authoring program or application (e.g., 1202) may exit at 1611. In some embodiments the processes at 1602-1609 may be carried out by an association module such as that illustrated at 1203, while 1610 may be carried out by a storage access module such as that illustrated at 1204.

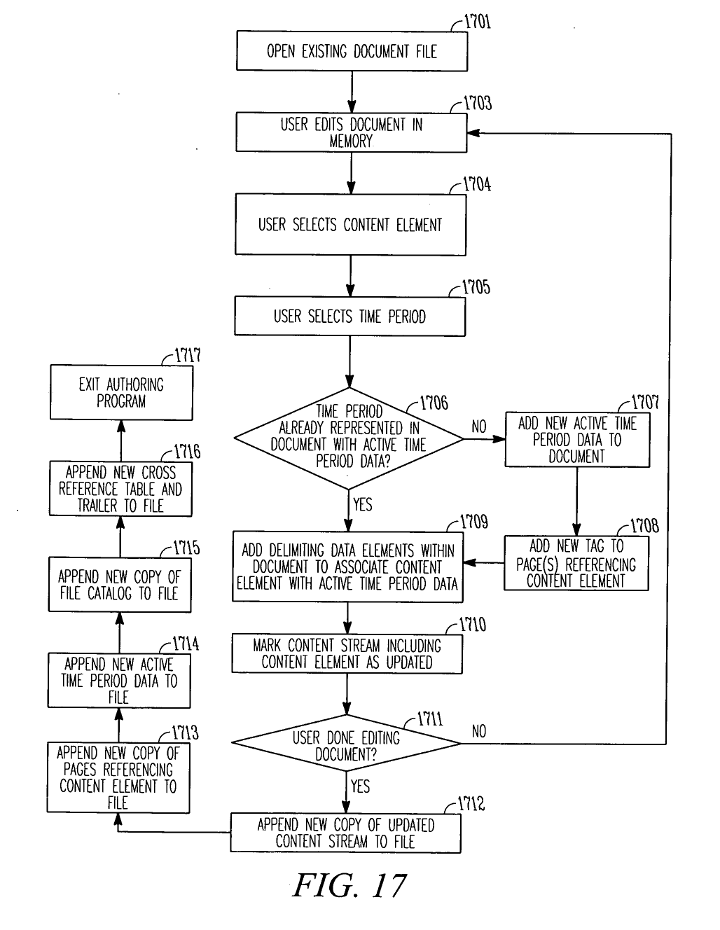

FIG. 17 is a flowchart illustrating a method for authoring electronic content, such as, for example, an electronic document, in which a content element may be associated with active time period data encapsulated in an optional content group, by the use of delimiting data element, in which the electronic document is stored in a form such as that represented in FIG. 10 or FIG. 11, as used in an example embodiment. FIG. 17 illustrates a method suited to working with electronic documents stored in data structures such as those illustrated in FIGS. 10 and 11 in which updating of data objects is done by appending new replacement data objects into additional main data object sections such as 1140.

At 1701, an existing electronic document file or other electronic content, structured, for example, as that of FIG. 10, is opened and made available for editing by a user, through the action of a storage access module 1204. This opening may include storing the electronic document in a memory 1206. Once opened and available in memory 1206, the electronic document may be edited at 1703 by a user, the editing being in some embodiments facilitated by an association module 1203. As in the method illustrated in FIG. 16, the editing may include creating, adding, moving, or deleting various content elements from association with, or literal inclusion in, the electronic document.

To begin the process of associating an active time period with a content element, a user (for example, via a GUI) may select a content element within the electronic document, or within a GUI representation of the document, or by some other mechanism. It is this content element that is to be made time-dependently visible within a rendering of the electronic document or otherwise time-dependently included in the electronic document, by being associated with active time period data. At 1705, the user may select a time period that is to be specified by active time period data associated with the content element. The entering or selection of this time period may be done in a number of ways, as described above with respect to the processing at 1605. At 1706, a determination is made of whether the selected time period is already represented by active time period data within the document or otherwise available in memory 1206. If not, processing continues at 1707 in which new active time period data corresponding to the selected time period is added or otherwise associated with the document and may be stored in memory 1206. In some embodiments, a new optional content group object having the new active time period data may be created at 1707 as well and stored in memory. At 1708, new symbolic tag data may be added to the page objects that reference the selected content element (if, for example, it appears as part of a content stream object associated with those page objects); the symbolic tag data also may need to be associated with an optional content group object containing the new active time period data. It will be appreciated that in the course of processing at 1707 and 1708, the updated file representing the electronic document new optional content group may have appended a new optional content group (OCG) object such as 1134 and new replacement page objects such as 1135.

In either scenario determined at 1706, processing may continue at 1709. At 1709, delimiting data elements may be added to the element document, which in some embodiments may be accomplished by modifying the data within a content stream object in memory 1206 that contains the selected content element to identify or delimit the content item in such as way as to associate it with the active time period data. This association may be done by ensuring an optional content group object that contains the active time period data is referenced by symbolic tag data in a page object, where the page object also references a content stream object containing the content element delimited by a start/end pair that is tagged by the symbolic tag. Having so modified a content stream object containing the selected content element, that content stream object may be marked as updated at 1710. If the user is not done editing the electronic document, as determined at 1711, processing may continue at 1103 for further editing, content element marking and active time period association, etc. It will be appreciated that the processing of 1703-1710 may be carried out, in some embodiments, by the association module 1203, with assistance from content creation module 1205.

If the user is done editing as determined at 1711 (such as for example by the user pressing a “save” button on a GUI, or an “exit” button and confirming that the user does in fact wish to exit the authoring system 1102), processing may continue at 1712. At 1712, an updated copy of any modified (e.g., by being marked as updated at 1710) content stream objects (such as, for example, 1138) may be appended to a file containing a representation of the electronic document, these being placed into an appended section of the file corresponding to a further main data object section, such as second main data object section 1140. At 1713, new copies of any modified pages (such as, for example, 1135) that reference newly active time period-associated content (such as via content elements' being part of a content stream) may be appended in like manner to the file. At 1714, new active time period data, newly associated to content element(s) may be appended into the file, for example by appending optional content group object(s) (such as, for example, 1134) that encapsulate the active time period data. At 1715, a new copy of a document catalog object that includes data or references to any newly-appended optional content group objects stored at 1714 may be appended to the file. At 1716, a new cross-reference table, such as 1141, corresponding to the newly-appended data objects and their relationships or replacement of already-existing data objects in the file and providing location information within the compound (e.g., original plus appended main data object section(s)) file is appended to the file. At 1716, in some embodiments, a new trailer such as 1142 may also be appended to the file. Finally at 1717, the authoring program or authoring system 1202 may exit.

It will be appreciated that the processing at 1712-1716 may be carried out by a storage access module 1204. it will be further appreciated that the method illustrated in FIG. 17 may be carried out numerous times, appending at each iteration further data objects to a file and adding such cross-reference sections and trailers as to keep the compound file in a machine-readable state.

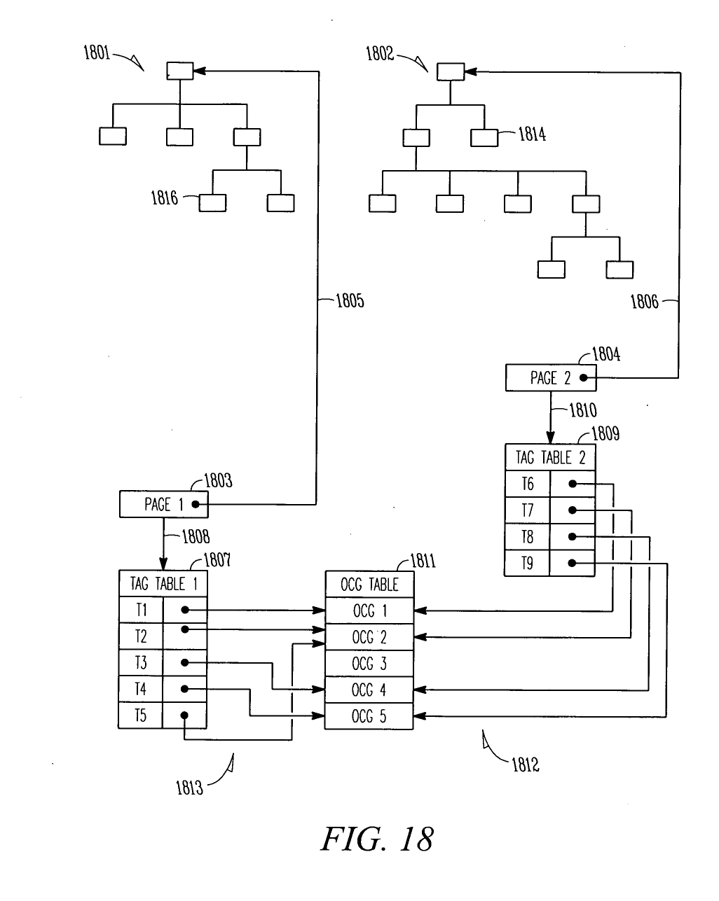

FIG. 18 shows a diagrammatic representation of a data structure that may be used by an authoring system to allow content elements associated with electronic content to be associated with active time period data encapsulated in optional content groups using delimiting data element tags, as used in an example embodiment.

The FIGS. 13-17 have described various aspects of the processing carried out by authoring systems such as illustrated at 1202. FIG. 18 illustrates a diagrammatic representation of parts of an example data structure that may be used by authoring system 1202 (and may, in some embodiments, be maintained in memory 1206) to support the authoring procedures. Data structures such as that shown in FIG. 18 may be used in representing electronic documents stored in data structures such as those illustrated in FIG. 10 and 11, although it will be appreciated that similar data structures may be applied to the authoring and processing of various kinds of electronic content and data structures representing such content.

In FIG. 18, two page objects are illustrated at 1803 and 1804. These page objects may reference content elements, In FIG. 18, each of page objects 1803 and 1804 are represented as referencing via references 1805 and 1806, respectively, two content stream objects 1802 and 1802, respectively. Although a one-to-one relationship is suggested in FIG. 18, a many-to-many relationship between page objects and content stream objects is possible. As shown in FIG. 18, content streams may be represented as tree structures, in which the entire content stream is represented by the root or top node, and the various content elements that are part of the content stream may be represented by various internal and leaf nodes. By using such tree-based structures, content elements may be nested, and by applying a delimiting data element to a particular node in a content stream object tree, the content element (which may be simple or composite) may be identified by the delimiting data element. If the delimiting data element is associated (directly or indirectly) with active time period data, the application of the delimiting data element to a node representing a content element may serve to associate that content element to active time period data.

In addition to example relationships between page objects 1803 and 1804 and content stream objects 1801 and 1802, FIG. 18 also illustrates symbolic tag data tables 1807 and 1809, joined to page objects 1803 and 1804 via reference data 1808 and 1810, respectively. In addition, a global optional content group (OCG) object table 1811 is shown. This table may literally include, or in some embodiments, include references or pointers to, optional content group objects which themselves may contain active time period data. It will be appreciated that the symbolic tag data tables 1807 and 1809 include two columns and act to map a symbolic tag (e.g., t6, t7, etc.) to an optional content group object via the various references shown at 1812 and 1813. By maintaining such a data structure, an association module 1203 may maintain the data used in constructing and updating or modifying files and (e.g., persistent) data structures of the type illustrated in FIGS. 10 and 11, as well as other similar and dissimilar file structures suited to storing other kinds of electronic content in addition to electronic documents.

The procedures illustrated in FIGS. 13-17 may be implemented including facilitation by use of a data structure such as that illustrated in FIG. 18; this facilitation is described here with respect to certain operations of FIG. 17. When a user selects a content element at 1704, a corresponding node (such as, for example, node 1814 or node 1816) in a content stream tree (e.g., within 1801) may be flagged. When a new active time period is added to the electronic document at 1707, a corresponding optional content group object containing active time period data corresponding to the new active time period may be added to the OCG object table 1811. When the operation at 1708 occurs, that of adding of a new symbolic tag data to a page referencing the content element, this may be implemented by determining which page(s) reference the content stream object containing the flagged node and updating the symbolic tag tables corresponding to those page(s) to include the new symbolic tag and a reference to the optional content group object that contains the new active time period data. Finally, the operation at 1709 may be implemented by applying a delimiting data element, including the new symbolic tag, to the flagged node. This delimiting element may be represented in a GUI or in a stored file as a start/end pair surrounding the representation of the content element

It will be appreciated that a reverse process may be used to change or remove an active time period from a content element.

Example Rendering, Reading, and Accessing Systems and Methods

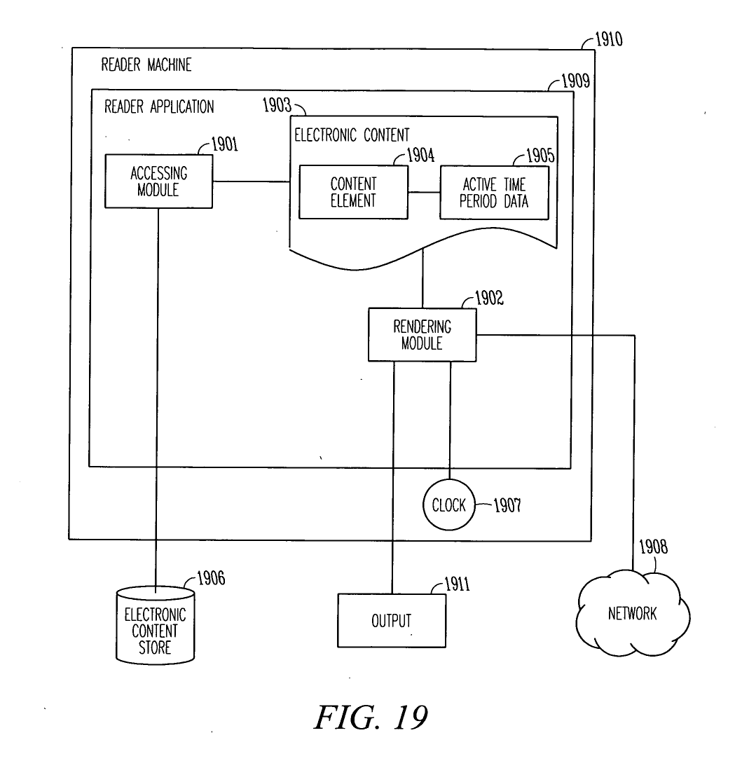

Having described authoring systems, the following paragraphs, making reference to FIGS. 19 through 23, describe systems and methods for rendering or reading electronic content that may be represented according so data structures, such as, for example, those illustrated in FIGS. 3-11.

FIG. 19 is a diagrammatic representation of a system for facilitating reading, carrying out rendering, or otherwise making accessible electronic content having associated content elements, where the content elements are associated with active time period data, as used in an example embodiment. In FIG. 19, a reader application 1909, such as a renderer application, may run on a reader machine 1910. The reader application 1909 may include an accessing module 1901 and a rendering module 1902, as well as a memory or other computer-readable medium (not shown) on which to store electronic content 1903, to which is associated one or more content elements, such as content element 1904, some of the content elements associated with various active time period data (“ATPD”) 1905, an ATPD specifying the time period during which the association between the electronic content and a particular content element is active. The electronic content 1903 may, for example be an electronic document such as a page-descriptive electronic document, or in some embodiments be some other type of electronic content.

An accessing module 1901 may be connected with an electronic content store 1906, from which the electronic content 1903, content element 1904 and active time period data 1905, may be retrieved. Electronic content store 1906 may be stored as part of a file system or other mass storage device, and may be included within the reader machine 1910 or may be located remotely and/or accessible to the reader machine 1910 via a network or other indirect connection. A rendering module 1902 may be connected to a network 1908, to an output device 1911 (such as a screen, or the input to a further processing module), and/or to a clock 1907. In some embodiments, an authoring module (not shown) may be part of the reader application 1909, to allow both authoring and reading procedures to be carried out within the same application, such as, for example, those described in the previous section.

The accessing module 1901 may serve to access the electronic content 1903 (as well as its associated data objects, such as content element 1904 and active time period data 1905) such access for example including retrieving the electronic content 1903 from an electronic content store 1906, and to make it available for processing by a rendering module 1902. A rendering module 1902 may serve to receive current time period data, and to use the current time period data and the active time period data associated with a content element, such as at 1904 to determine whether the association between the electronic content 1903 and the content element 1904 is active and when active to render or otherwise make accessible the content element as part of a rendering or otherwise accessible representation of the electronic content 1903. Various techniques may be used by the rendering module 1902 for receiving a current time period data. For example, it may be constructed from the output of a clock 1907, such as system clock, it may be constructed from a time retrieved via the network 1908, such as, for example, from a standard time Internet site, or in may be constructed from a time expression received from a user, via a GUI dialog box or other mechanism. The receiving of a current time period data may occur once, at the beginning of processing of the electronic content 1903 by the rendering module 1902 or may occur multiple times as the rendering of the electronic content progresses. For example, the rendering module 1902 may prompt the user for current time period data as each content element that is associated with an active time period data is processed. The rendering module 1902 may in some embodiments compute current time period data from what appears to be a time indication of a single point in time. For example, if a user inputs a current time as “July 2006”, the rendering module 1902 may construct current time period data describing “01-July_{—}2006 00:00:00.00 through 31-July_{—}2006 23:59:59.99” from that time input, a similar technique being applied to received clock output or other sources, to whatever accuracy is required. In some embodiments, a content element may be considered active if it has an active time period data associated with it, and that active time period data overlaps with current time period data.

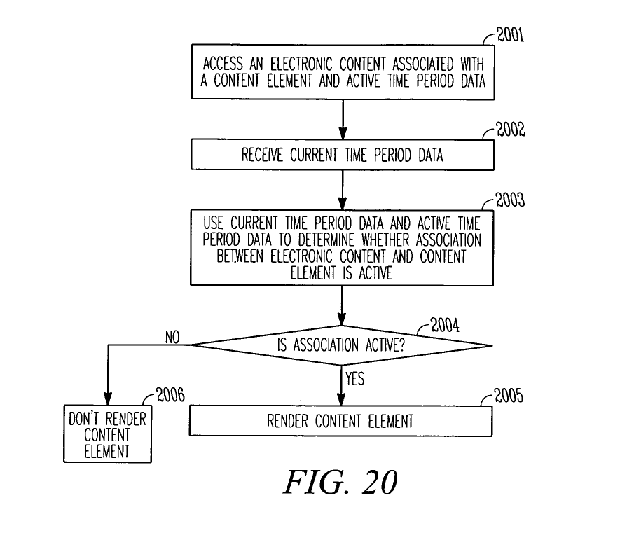

FIG. 20 is a flowchart illustrating a method for rendering or otherwise making accessible electronic content having associated content elements, where the content elements are associated with active time period data, as used in an example embodiment. At 2001, electronic content associated with a content element, as well as an active time period associated with the content element may be accessed, by reader application 1909. At 2002, current time period data may be received, for example, as described above. At 2003, the current time period data may be used with the active time period data to determine whether the association between the electronic content and the content element is active. At 2004, this determination is made. If the association is active, the content element may be rendered or otherwise made accessible as 2005 as part of a making accessible (such as by rendering) of the electronic content. In some examples, this making accessible may involve including the content element within the electronic content, such as for further processing, searching, or other tasks. On the other hand, if the association is not active, the content element is not made accessible nor rendered, as indicated at 2006. It will be appreciated that if the electronic content is associated with multiple content elements that have associated active time period data, operations 2003-2005 may be repeated for each such content element. In some embodiments, the lack of active time period associated with a content element may allow that content element to be rendered regardless of current time period data.

The operations 2002-2005 illustrated in FIG. 20 may, in some embodiments, be carried out by rendering module 1902 during the process of rendering electronic content, such as 1903. In some embodiments, operation 2001 is carried out by an accessing module 1901.

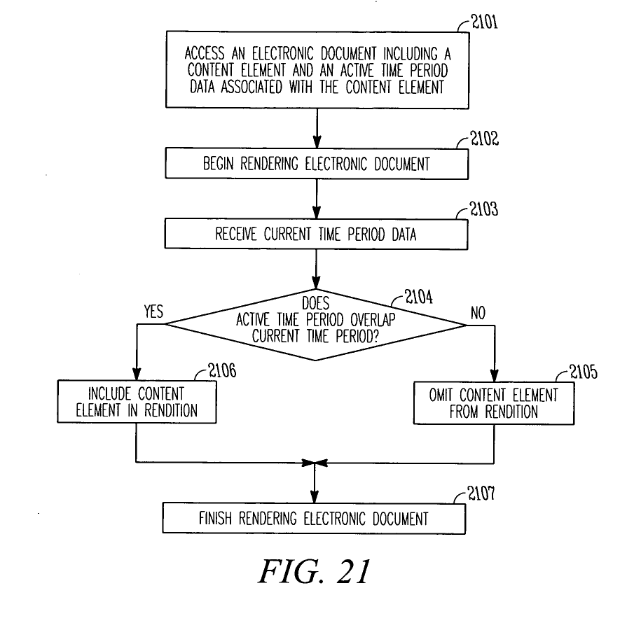

FIG. 21 is a flowchart illustrating a method for rendering or otherwise making accessible an electronic document having associated content elements, where the content elements are associated with active time period data and rendered according to a current time period, as used in an example embodiment. At 2101, an electronic document or other electronic content is accessed, the electronic document literally including or otherwise associated with a content element, the content element being associated with active time period data. At 2102, the process of rendering the electronic document begins. At 2103, current time period data is received, the current time period data being constructed, for example, from a time provided by a clock 1907. At 2104, a determination is made as to whether the active time period specified by the active time period data overlaps with the current time period specified by the current time period data. If not, the content element is omitted from the rendering at 2105. If so, the content element is included in a rendering of the electronic document at 2106. In either case, the rendering process of the electronic document is completed at 2107. Although the method of FIG. 21 is shown in terms of a single content element, it will be appreciated that multiple content items associated with various active time period data may be associated with an electronic document, in which case operations 2104 and 2105 or 2106, and in some embodiments, 2103, may be carried out with respect to some or all of the content items and their associated active time period data.

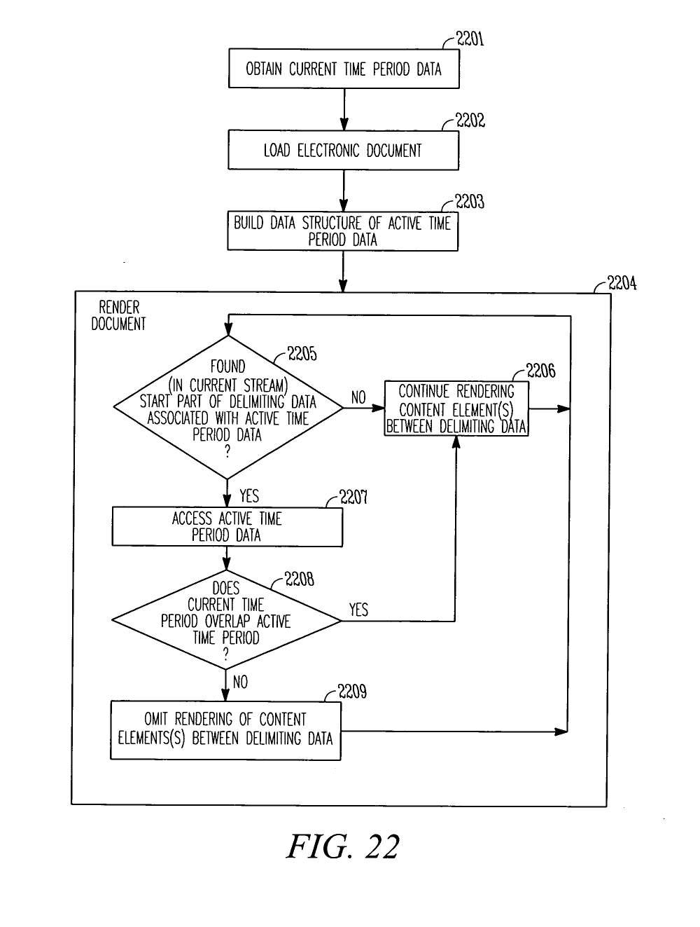

FIG. 22 is a flowchart illustrating a method for rendering or otherwise making accessible an electronic document having associated content elements, where the content elements are associated with active time period data and rendered according to a current time period, using active time period data and delimiting tags, as used in an example embodiment. The operations illustrated in FIG. 22 may, in some embodiments, be carried out by rendering module 1902, with the exception of operation 2202 which may be carried out by the accessing module 1901. The method illustrated in FIG. 22 may be used, for example, when content elements are contained in content stream objects, such as in file structures or other data structures of the type illustrated in FIGS. 10 and 11. While FIG. 22 illustrates a process that may be used in the rendering of electronic documents with associated content elements identified by delimiting data elements that associate the content element with active time period data, similar processes may be used in the rendering or otherwise making accessible of a variety of electronic content types.

At 2201, current time period data, constructed in some embodiments, from a current time reading from the system clock 1907, or in some embodiments, constructed from a user time input, or a time received from some location in network 1908. At 2202, the electronic document or other electronic content is loaded; this loading may include loading associated content elements, content streams, and other data structures or objects, such as for example, as illustrated in FIG. 10 and 11. These data structures and objects may be stored in a memory associated with reader machine 1910. Once loaded, a data structure may be built at 1203, similar to FIG. 18 in some embodiments, that contains such information as mapping(s) from symbolic tags to time periods represented by active time period data. Once this data structure has been built from the loaded file, rendering the electronic document may proceed, a compound operation represented at 2204.

In the process of rendering the electronic document, or making accessible a version of the electronic document or other electronic content that includes certain content element(s), such as those whose active time period overlaps current time period, various content stream data objects (e.g.,. 1138) associated with page objects (e.g., 1135) may be processed. In the course of this processing, the rendering module 1902, for example, may scan within a content stream for the start part of a start/end-type delimiting data element that is associated with active time period data. If, as each item of data in a content stream object is scanned and identified, and not identified as start part of such a start/end-type delimiter pair at 1205, the content elements following or including the item of data may be rendered normally. On the other hand, if a start part of a start/end delimiter pair is found, and the start part is determined to be associated with active time period data (directly or indirectly, or via the data structure built at 2203), such as by including a symbolic tag referencing the active time period data, processing continues at 2207. At 2207, active time period data (e.g., associated with the symbolic tag that may be present in the start part of the start/end delimiter pair) is accessed, such as, for example, by lookup in the in the data structure built at 2203. At 1208, a comparison may be made between the active time period specified by the active time period data and the current time period specified by the current time period data collected at 2201. If the time periods overlap, rendering of the content element(s) identified by the start/end delimiter pair may continue at 2206, since these content elements are to be included in the electronic document. On the other hand, if the time periods do not overlap, rendering of the content items between the start/end delimiter pair may be suppressed or omitted at 2209 until the matching end par of the delimiter is pair is reached in the e.g. sequential processing of a content stream object.

In some embodiments, nonvisible content elements (such as, for example, changes to font colour), although they are identified by delimiting data elements as associated with a particular active time period that does not overlap with the current time period, may still be included in a rendering of an electronic document by affecting other content elements that occur later in the content stream object's data sequence.

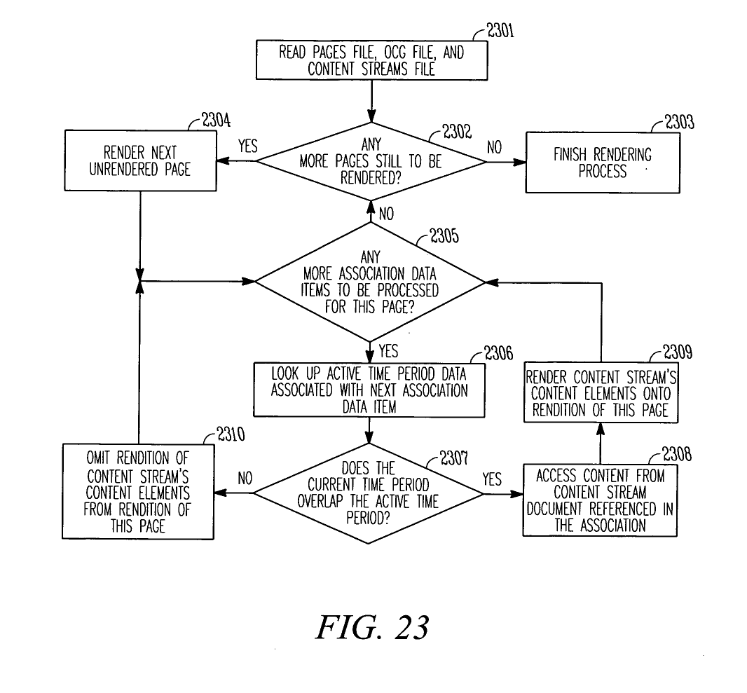

FIG. 23 is a further flowchart illustrating a method for rendering or otherwise making accessible a multi-file, page-organized electronic document having associated content elements, where the content elements are associated with active time period data via optional content groups, as used in an example embodiment.

In the process illustrated in FIG. 23, it is assumed that an electronic content is organized into pages, such as, for example, a page-descriptive electronic document. Moreover, it is assumed that one file (a “pages file”), which may be stored in an electronic content store such as 1206 contains page objects containing information describing pages, and that a further file (an “OCG file”) contains optional content group data, including active time period data, and that a yet further file (a “Content Stream File”) that stores one or more content stream objects that contain descriptions of content elements. The page file may also include references to the other two files, as well as association data items, each association data item being associated with a particular page, as well as with a content stream item (and by extension the content elements described by that content stream) and with an optional content group object. Thus, the content elements described in a particular content stream are thereby associated with active time period data with respect to a particular page. The process illustrated in FIG. 23 may be used as part of an electronic document (or other electronic content) rendering process carried out by reader application 1909.

At the beginning of the process illustrated in FIG. 23, the pages file is read, at 2301, and suitable data structures are built in memory and made available to a rendering module 1902. In some embodiments, the OCG file and content stream file are also read and suitable internal representations of their data built. These operations may, in some embodiments, be carried out by an accessing module 1901. Once this data has been loaded and made available in memory, the rest of the operations shown in FIG. 23 may be accomplished by a rendering module 1902.

At 2302, it may be determined whether there remain any further pages to be rendered. If not, the rendering process may finish at 2303. If more pages remain to be rendered, the next not-yet-rendered page is rendered at 2304, this rendering process of the next page commencing at 2305, the next page becoming the current page at this point.

At 2305, the association data items between content stream objects and optional content groups for the page being rendered, which may have been loaded from the pages file, is examined to see if any more association data items associated with the page being rendered associate content streams objects and optional content group data remain to be processed. If not, that processing of the current page may be considered complete and processing continues back at 2302 with the next page. On the other hand, if a further association data element associated with the page being rendered associates a content stream with an optional content group, the active time period data contained in that optional content group object is looked up at 2306 and compared for overlap with current time period data (retrieved from, for example, clock 1907) at 2307. If there is no overlap, the content stream and thus its content elements may be omitted at 2310 from the rendition of the current page. But if there was overlap, the content stream object may be accessed at 2308 and its content elements may rendered onto a rendition of the page being rendered, at 2309. Thereafter, processing may continue at 2305, processing further association data items associated with the page being rendered.

While a number of techniques have been described that are suited to rendering or otherwise making accessible various types of electronic content having time-based optional content elements, it will be appreciated that the foregoing methods such as those illustrated in FIGS. 20-23 are examples and that many other methods, in some cases, including techniques from one or more of the processes illustrated, may be used. It will be further appreciated that content elements may exist that have no association with active time period elements and that in some embodiments, when these content elements are processed during any of the processes illustrated in FIGS. 20-23, they may be included regardless of current time period data, or in some other embodiments, omitted regardless of current time period data.

XML and HTML Examples

In the tables that follow, several data structures are presented as they may be used to store electronic content, such as electronic documents, with time-based optional portions.

```
TABLE 1
<?xml version=”1.0”>
<ElectronicDocument>
<PageTree>
    <id>pageroot</id>
    <pageCount>1</pageCount>
    <childPages>
        <child>Page1</childId>
    </childPages>
</PageTree>
<Page>
    <id>Page1</id>
    <parentPageIds></parentPageIds>
    <drawingArea upperLeftX=”0” upperLeftY=”0” lowerRightX=”612”
lowerRightY=”792”>
    <contentId>content1</contentId>
</Page>
<Content>
    <id>content1</id>
    <Circle centerX=”200” centerY=”400” radius=”30”
    color=”blue”></Circle>
    <Image upperLeftX=”40” upperLeftY=”20”
source=”C:\userpics\mypicture.jpg”></Image>
    <Text>
        <font name=”roman”></font>
        <textbox upperLeftX=”300” upperLeftY=”600” width=”40”
height=”90”></textbox>
        <textString>
        a more mellow quintadena with a less \
        prominent 3rd and 5th harmonic
        </textString>
    </Text>
</Content>
</ElectronicDocument>
```

Table 1 illustrates how a basic page-descriptive electronic document file may be formatted using XML. The file contains a page tree object, referencing a single page object. The page object has a <drawingArea> tag specifying its drawing area, in which content elements are to be rendered in a rendition of the page, as well as a <contentId> tag specifying the identifier of a content stream associated with the page. The content stream object itself is set off within <Content> tags. This content stream object describes the three content elements associated with it, namely a circle, an image from a particular file, and a short text to be displayed in a text box on the rendition of its page.

Table 2A and Table 2B show the same electronic content as Table 1, except that some content elements are marked as time-based optional content.

```
TABLE 2A
<?xml version=”1.0”>
<ElectronicDocument>
<OCG>
    <name>Time Interval 1</name>
    <type>time</type>
    <tag>t1</tag>
    <enabled>True</enabled>
    <startTime>2006-06-21 21:15:45 −8</startTime>
    <endTime>2006-09-30 23:59:59 −8</endTime>
</OCG>
<PageTree>
    <id>pageroot</id>
    <pageCount>1</pageCount>
    <childPages>
        <child>Page1</child>
    </childPages>
</PageTree>
<Page>
    <id>Page1</id>
    <parentPageIds></parentPageIds>
    <drawingArea upperLeftX=”0” upperLeftY=”0” lowerRightX=”612”
lowerRightY=”792”>
    <contentId>content1</contentId>
</Page>
<Content>
    <id>content1</id>
    <Circle centerX=”200” centerY=”400” radius=”30”
    color=”blue”></Circle>
    <ocg tag=”t1”>
        <Image upperLeftX=”40” upperLeftY=”20”
source=”C:\userpics\mypicture.jpg”></Image>
        <Text>
            <font name=”roman”></font>
            <textbox upperLeftX=”300” upperLeftY=”600”
width=”40” height=”90”></textbox>
            <textString>
            a more mellow quintadena with a less \
            prominent 3rd and 5th harmonic
            </textString>
        </Text>
    </ocg>
</Content>
</ElectronicDocument>
```

In the example XML file or data structure of Table 2A, in addition to the objects shown in Table 1, it will be observed that an optional content group object (identified by <OCG> tags) is present to identify a “Time Interval 1”, to provide a symbolic tag “t1”, and to indicate an absolute active time period (indicated by <startTime> and <endTime> tags). The content stream object of Table 2A differs from that of Table 1 by having the data describing the image content element (“mypicture.jpg”) and the text content element enclosed by </ocg> tags, these tags serving as delimiting start/end data elements indicating that the enclosed content elements are to be associated with the active time period interval in the optional content group object, by virtue of the tag=“t1” symbolic tag within the start delimiting element (e.g, <ocg tag=“t1”>)

```
TABLE 2B
<?xml version=”1.0”>
<ElectronicDocument creationDate=”2006-06-21 21:15:45 −8”>
<OCG>
    <name>Time Interval 1</name>
    <type>time</type>
    <tag>t1</tag>
    <enabled>True</enabled>
    <startTime>24h</startTime>
    <endTime>72h</endTime>
</OCG>
<PageTree>
    <id>pageroot</id>
    <pageCount>1</pageCount>
    <childPages>
        <child>Page1</child>
    </childPages>
</PageTree>
<Page>
    <id>Page1</id>
    <parentPageIds></parentPageIds>
    <drawingArea upperLeftX=”0” upperLeftY=”0” lowerRightX=”612”
lowerRightY=”792”>
    <contentId>content1</contentId>
</Page>
<Content>
    <id>content1</id>
    <Circle centerX=”200” centerY=”400” radius=”30”
    color=”blue”></Circle>
    <ocg tag=”t1”>
        <Image upperLeftX=”40” upperLeftY=”20”
source=”C:\userpics\mypicture.jpg”></Image>
        <Text>
            <font name=”roman”></font>
            <textbox upperLeftX=”300” upperLeftY=”600”
width=”40” height=”90”></textbox>
            <textString>
            a more mellow quintadena with a less \
            prominent 3rd and 5th harmonic
            </textString>
        </Text>
    </ocg>
</Content>
</ElectronicDocument>
```

The XML file illustrated Table 2B is very similar to that illustrated in Table 2A. It will be observed that it includes a creationDate attribute within its opening <electronicDocument>. In addition, the optional content group object includes active time period data start time and end time specified in a number of hours, having the semantics that the active time period, in this example, begins 24 hours after the file creation date and ends 72 hours after the creation date.

Table 3 illustrates a somewhat more elaborate file structure, again implemented in XML. In this example, the electronic document is illustrated as having two pages, each described by a page object, and two content streams, in this example, one content stream associated with each page object.

```
TABLE 3
<?xml version=”1.0”>
<ElectronicDocument>
<OCG>
    <name>Time Interval 1</name>
    <type>time</type>
    <enabled>True</enabled>
    <startTime>2006-06-21 21:15:45 −8</startTime>
    <endTime>2006-09-30 23:59:59 −8</endTime>
</OCG>
<PageTree>
    <id>pageroot</id>
    <pageCount>1</pageCount>
    <childPages>
        <child>Page1</child>
    </childPages>
</PageTree>
<Page>
    <id>Page1</id>
    <childPages>
        <child>Page2</child>
    </childPages>
    <drawingArea upperLeftX=”0” upperLeftY=”0” lowerRightX=”612”
lowerRightY=”792”>
    <contentId>content1</contentId>
    <Properties>
        <ocgTag name=”Time Interval 1” tag=”t1”></ocgTag>
    </Properties>
</Page>
<Page>
    <id>Page2</id>
    <parentPages>
        <parent>Page1</child>
    </parentPages>
    <drawingArea upperLeftX=”0” upperLeftY=”0” lowerRightX=”612”
lowerRightY=”792”>
    <contentId>content2</contentId>
    <Properties>
        <ocgTag name=”Time Interval 1” tag=”ocg_t_1”></ocgTag>
    </Properties>
</Page>
<Content id=”content2”>
    <Square centerX=”200” centerY=”400” diagonal=”75”
color=”red”></Square>
    <ocg tag=”ocg_t_1”>
        <Text>
            <font name=”roman”></font>
            <textbox upperLeftX=”10” upperLeftY=”60” width=”80”
height=”90”></textbox>
            <textString>
            Hello world!
            </textString>
        </Text>
    </ocg>
</Content>
<Content id=”content1”>
    <Circle centerX=”200” centerY=”400” radius=”30”
    color=”blue” ></Circle>
    <ocg tag=”t1”>
        <Image upperLeftX=”40” upperLeftY=”20”
source=”C:\userpics\mypicture.jpg”></Image>
        <Text>
            <font name=”roman”></font>
            <textbox upperLeftX=”300” upperLeftY=”600”
width=”40” height=”90”></textbox>
            <textString>
            a more mellow quintadena with a less \
            prominent 3rd and 5th harmonic
            </textString>
        </Text>
    </ocg>
</Content>
</ElectronicDocument>
```

The optional content group object includes a name (e.g., “Time Interval 1”) and active time period data specifying an active time period but does not provide a symbolic tag. Instead each page object by the use of the <ocgTag>tags each provides a separate alias (e.g., “t1” in page 1, and “ocg_t_{—}1” in page 2) which are used within the start/end delimiting data in content stream object 1 and content stream object 2, respectively. It is these page-specific symbolic tags when used with the <ocg> start/end delimiter paris in the content stream objects that indicate an association between the enclosed content element descriptions and the active time period data in the OCG object to which they (indirectly, via their associated page's <Properties> section) are associated.

Table 4 illustrates how a word processing application file, stored using an XML syntax, may be implemented using time-based optional content so that, for example, certain portions of the word processing document are printable only during a certain time interval.

```
TABLE 4
<?xml version=”1.0”>
<WordProcessorDocument>
<OCG>
    <name>Time Interval 1</name>
    <type>time</type>
    <enabled>True</enabled>
    <tag>t1</tag>
    <startTime>2006-06-21 21:15:45 −8</startTime>
    <endTime>2006-09-30 23:59:59 −8</endTime>
</OCG>
<Content>
<center><font size=”24”>Research And Concert Brochure</font></
center>
<newline></newline>
<newline></newline>
<paragraph><font size=”10” face=”Roman”>
Founded in 2001 and located in San Francisco, California,
is a research and development initiative and think
tank dedicated to the popularization of acoustic music.
We focus on promoting fine quality concerts for all ages.
</font></paragraph>
<ocg tag=”t1”>
</font size=”12”>
<bold>Concert Series Through September 30, 2006</bold><newline></
newline>
June 18: Car Door Quartet, Hill Country Club, Brownsville,
OH<newline></newline>
July 4: Seven People Band, Quintadena Showroom and Pub, Castro
Valley,
CA<newline></newline>
August 14: Dance Again Orchestra, Kinura Lounge, Smithville,
TN<newline></newline>
</ocg>
</font>
</Content>
</WordProcessorDocument>
```

In the example file shown above, the body of the document is described within the <Content> tag pair. In the example above, a document has, among its associated content elements, texts giving the dates for various concerts, as well as a paragraph describing the organization that stages the concerts. It will be further observed that these concert date texts are enclosed within a start/end delimiter data, having a start element <ocg tag=“t1”>. In some embodiments, when a user prints this document, those concert dates are only included in the printed rendition of the document during the active time period described in the active time period data of the optional content group object having the tag “t1”.

Table 5 shows a more complex example electronic content file of a somewhat similar arrangement to the data structures illustrated in FIGS. 10 and 11.

```
TABLE 5
<?xml version=”1.0”>
<ElectronicDocument>
<Catalog>
    <OCGList>
        <OCGData>
            <id>time_int_1</id>
            <name>ThruEndOfSeptember</name>
            <type>time</type>
            <enabled>True</enabled>
        </OCGData>
    </OCGList>
</Catalog>
<OCG id=”time_int_1”>
    <VisibilityInterval>
        <start>2006-06-21 21:15:45 −8</start>
        <end>2006-09-30 23:59:59 −8</end>
    </visibilityInterval>
</OCG>
<PageTree>
    <id>pageroot</id>
    <pageCount>1</pageCount>
    <childPages>
        <child>Page1</child>
    </childPages>
</PageTree>
<Page>
    <id>Page1</id>
    <childPages>
        <child>Page2</child>
    </childPages>
    <drawingArea upperLeftX=”0” upperLeftY=”0” lowerRightX=”612”
lowerRightY=”792”>
    <contentId>content1</contentId>
    <Properties>
        <ocgTag id=”time_int_1” tag=”t1”></ocgTag>
    </Properties>
</Page>
<Content id=”content1”>
    <Circle centerX=”200” centerY=”400” radius=”30”
    color=”blue”></Circle>
    <ocg tag=”t1”>
        <Image upperLeftX=”40” upperLeftY=”20”
source=”C:\userpics\mypicture.jpg”></Image>
        <Text>
            <font name=”roman”></font>
            <textbox upperLeftX=”300” upperLeftY=”600”
width=”40” height=”90”></textbox>
            <textString>
            a more mellow quintadena with a less \
            prominent 3rd and 5th harmonic
            </textString>
        </Text>
    </ocg>
</Content>
</ElectronicDocument>
```

This example electronic document file has a number of XML-syntax objects as seen in previous tables. In addition, it has a <Catalog>-tagged catalog object that may serve as a file catalog and includes information about the (one) optional content group object in the document, such as its name and a global identifier (“time_int_{—}1”). The optional content group object proper (matched to its entry in the catalog object via the id=″time_int_{—}1 attribute in its opening <OCG> tag) has active time period data represented by a <visibilityInterval> tag pair. Similarly to Table 3, the association between content elements in the content stream objects and the active time period interval in the optional content group is effected by using the <ocgTag> tag in the page object to define a symbolic tag, which is used in the <ocg>start/end delimiting data surrounding the content elements.

Table 6 illustrates an HTML (e.g., hypertext) document that also literally includes time-based optional content.

```
TABLE 6
<!DOCTYPE html PUBLIC “-//w3c//dtd html 4.0 transitional//en”>
<html>
<head>
<meta http-equiv=“Content-Type” content=“text/html;
charset=iso-8859-1”>
<title>Research Online Brochure</title>
<!--
    <OCG>
        <name>Time Interval 1</name>
        <type>time</type>
        <tag>t1</tag>
        <enabled>True</enabled>
        <startTime>2006-06-21 21:15:45 −8</startTime>
        <endTime>2006-09-30 23:59:59 −8</endTime>
    </OCG>
//-->
</head>
  <body>
<p><font size=“−1”>Founded in 2001 and located in San Francisco,
California, is a research and development initiative and &#8216;think
tank&#8217; dedicated to the popularization of making <font> </p>
<ocg tag=”t1”>
  <p><a name=“tt2”></a>
<font size=”−1”>For various reasons, a mere historical
curiosity, heard by few, understood and appreciated by even fewer. <br>
  </font></p>
<img src=”somepicture.jpg”>
</ocg>
  </body>
</html>
```

An HTML file formatted such a way may be used with a specialized HTML browser program. Such a browser program may obtain current time period data, and process the optional content group in the HTML header (e.g, <head>) section of the HTML file. The browser program may then render the content elements located between the <ocg tag=“t1”> tags within a rendering of the overall web page only if the current time period was included in the active time period described by the active time period data in the optional content group object associated with the symbolic tag (e.g., t1)

The final tables, Tables 7A, 7B, and 7C, illustrate how an electronic document or other electronic content formatted as three separate XML files may be formatted to have time-based optional content.

TABLE 7A

```
<?xml version=”1.0”>
<OptionalContentElectronicDocument>
<OCGSet>
    <OCG id=”ocg1”>
        <name>Time Interval 1</name>
        <type>time</type>
        <enabled>True</enabled>
        <startTime>2006-06-21 21:15:45 −8</startTime>
        <endTime>2006-09-30 23:59:59 −8</endTime>
    </OCG>
    <OCG id=”ocg2”>
        <name>Time Interval 1</name>
        <type>time</type>
        <enabled>True</enabled>
        <startTime>2006-10-01 00:00:00 −0</startTime>
        <endTime>2006-10-31 23:59:59 −0</endTime>
    </OCG>
</OCGSet>
<OptionalContentElectronicDocument>
```

```
TABLE 7B
<?xml version=”1.0”>
<ContentStreamDocument>
<ContentStream>
    <id>stream1</id>
    <Circle centerX=”200” centerY=”400” radius=”30”
    color=”blue”></Circle>
</ContentStream>
<ContentStream>
    <id>stream2</id>
    <Image upperLeftX=”40” upperLeftY=”20”
source=”C:\userpics\mypicture.jpg”></Image>
    <Text>
        <font name=”roman”></font>
        <textbox upperLeftX=”300” upperLeftY=”600” width=”40”
height=”90”></textbox>
        <textString>
        a more mellow quintadena with a less \
        prominent 3rd and 5th harmonic
        </textString>
    </Text>
</ContentStream>
</ContentStreamDocument>
```

```
TABLE 7C
<?xml version=”1.0”>
<PagesDocument>
<ContentStreamFile>
    <name>”C:\files\some_csf.xml”</name>
</ContentStreamFile>
<OCGFile>
    <name>”C:\files\some_ocg.xml”</name>
</OCGFile>
<PageTree>
    <id>pageroot</id>
    <pageCount>1</pageCount>
    <childPages>
        <child>Page1</child>
    </childPages>
</PageTree>
<Page>
    <id>Page1</id>
    <parentPageIds></parentPageIds>
    <drawingArea upperLeftX=”0” upperLeftY=”0” lowerRightX=”612”
lowerRightY=”792”>
    <associationsArray>
        <association contentStream=”stream1”
        ocg=”ocg2” ></association>
        <association contentStream=”stream2”
        ocg=”ocg1” ></association>
    </associationsArray>
</Page>
</PagesDocument>
```

Table 7A illustrates a file that provides two optional content group objects (e.g., having identifiers ocg1 and ocg2, respectively) grouped into an optional content group set. These optional content group objects, although they have active time period data, do not have symbolic tags per se. It will be appreciated that the file illustrated in Table 7A is similar semantically component 903 of FIG. 9.

Table 7B in contrast illustrates a file that provides data describing content elements arranged as parts of two content stream objects. The content streams are identified by <id> tags with names (e.g., stream1 and stream2). The content elements include text in a text box, a circle, etc. It will be appreciated that the file exemplified in Table 7B is similar semantically to component 902 of FIG. 9.

Finally, Table 7C provides page-descriptive information for the document. Two files, in this example, containing the XML formatted data shown Table 7A and 7B are referenced, followed by page information; the example electronic document illustrated in Tables 7A-7C has only one page. The page object (with identifier Page1) in Table 7C defines a drawing area in which content elements associated with the page are to be rendered, as well as an associations array. The associations array contains association data (in the form of <association> tags and contentStream and ocg attributes) that associates a (named, e.g., “ocg1”) optional content group object (and by extension, the active time period data contained within it) with a (named, e.g., “stream2”) content stream object. Whether the content elements described within a content stream object are rendered as part of a particular page or not depends on whether on not a current time period is contained within the active time period described by an optional content group object referenced by an association data element in that particular page that also references content stream object. Thus, it will be appreciated that files of the type illustrated in Table 7C

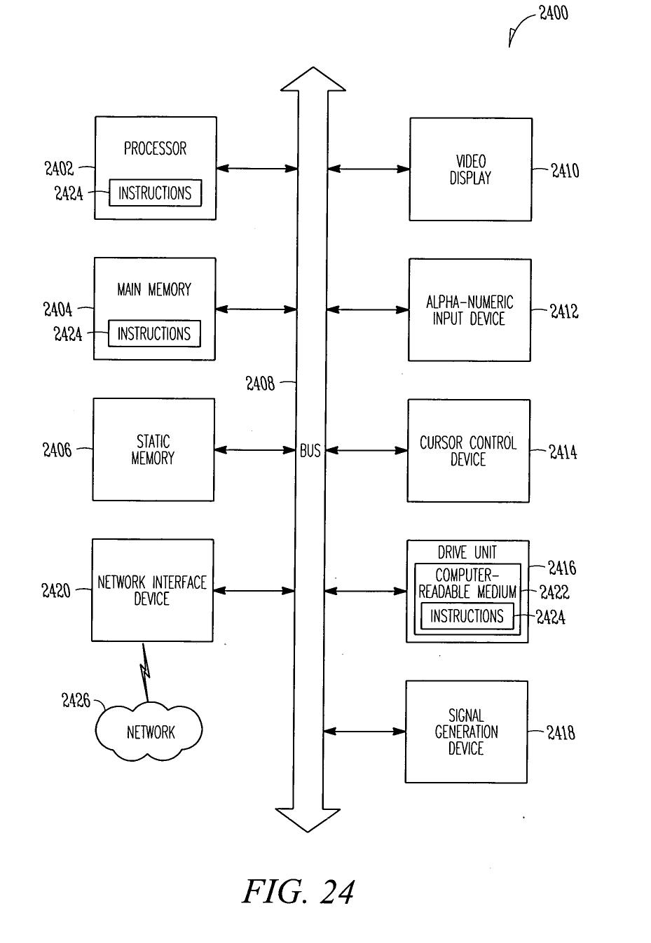

FIG. 24 shows a diagrammatic representation of machine in the example form of a computer system 2400 within which a set of instructions, for causing the machine to perform any one or more of the methodologies, methods, processes, or procedures discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2400 includes a processor 2402 (e.g., a central processing unit (CPU), a graphics processing unit (GPU) or both), a main memory 2404 and a static memory 2406, which communicate with each other via a bus 2408. The computer system 2400 may further include a video display unit 2410 (e.g., a liquid crystal display (LCD) or a cathode ray tube (CRT)). The computer system 2400 also includes an alphanumeric input device 2412 (e.g., a keyboard), a user interface (UI) navigation device 2414 (e.g., a mouse), a disk drive unit 2416, a signal generation device 2418 (e.g., a speaker) and a network interface device 2420.

The disk drive unit 2416 includes a machine-readable medium 2422 on which is stored one or more sets of instructions and data structures (e.g., software 2424) embodying or utilized by any one or more of the methodologies or functions described herein. The software 2424 may also reside, completely or at least partially, within the main memory 2404 and/or within the processor 2402 during execution thereof by the computer system 2400, the main memory 2404 and the processor 2402 also constituting machine-readable media.

The software 2424 may further be transmitted or received over a network 2426 via the network interface device 2420 utilizing any one of a number of well-known transfer protocols (e.g., HTTP).

While the machine-readable medium 2422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

A number of technical problems exist with respect to ensuring the currency of digital content. An examples of a technical problem that may be solved by embodiments presented herein may include excessive network traffic generated by web page requests for frequently-updated electronic content, which, according to some embodiments, may be replaced by fewer page requests for a single piece of electronic content having a number of separate content elements active in a time-dependent fashion. Another example of a technical problem that may be solved by embodiments presented herein is that of file management overhead. For example, a mass storage device in which a number of separate versions of an electronic document are stored, each version being a version appropriate for a particular time period may require more file system overhead data to manage than may be the case if only a single electronic document is stored. The embodiments presented herein may allow a single electronic document containing various content elements and associated active time period data as to suffice to represent the several separate versions.

Although an embodiment of the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A method comprising:
accessing electronic content of a page-descriptive electronic document, the electronic content being associated with a first content element that is renderable as being included in the electronic content, the first content element being associated with active time period data, the active time period data specifying a time period during which the first content element is active with respect to the electronic content, the electronic content being further associated with a second content element that is renderable as being included in the electronic content, at least one of the first and second content elements included within the electronic content of the page-descriptive electronic document, the first and second content elements being alternate paragraphs of the page-descriptive electronic document;
receiving current time period data;
determining that the first content element is not active with respect to the electronic content, the determining being based on the current time period data and on the active time period data, the first content element being a first alternate-portion of the page-descriptive electronic document; and
rendering the electronic content as being inclusive of the second content element and not inclusive of the first content element, the second content element being a second alternate-portion of the page-descriptive electronic document, the rendering being based on the determination that the first content element is not active with respect to the electronic content and the rendering of the electronic content as being inclusive of the second content element including presenting a view of second alternate-portion of the page-descriptive electronic document.

2. The method of claim 1, wherein the receiving of the current time period data includes at least one of reading a time from a clock, receiving the time as provided by a user, reading the time from a memory, or receiving the time via a network.

3. The method of claim I, wherein the current time period data specifies at least a current date.

4-5. (canceled)

6. The method of claim 1, wherein the electronic content includes digital data, and wherein the first content element is associated with the electronic content by being a portion of the digital data included in the electronic content, the portion being associated with the active time period data.

7. The method of claim 1, wherein the first content element is associated with the electronic content via inclusion, within the electronic content, of a reference to the first content element.

8. The method of claim 1, wherein the active time period data and the first content element are stored in separate files.

9. (canceled)

10. A system comprising:
a processor-implemented accessing module configured to access electronic content of a page-descriptive electronic document, the electronic content being associated with a first content element that is renderable as being included in the electronic content, the first content element being associated with active time period data, the active time period data specifying a time period during which the first content element is active with respect to the electronic content, the electronic content being further associated with a second content element that is renderable as being included in the electronic content, at least one of the first and second content elements included within the electronic content of the page-descriptive electronic document, the second content element being an alternate content element to be rendered when the first content element is outside of the active time period defined by the active time period data, the first and second content elements being alternate paragraphs of the page-descriptive electronic document; and
a processor-implemented rendering module configured to:
receive current time period data;
determine that the first content element is not active with respect to electronic content, the determining being based on the current time period data and on the active time period data; and
render the electronic content as being inclusive of the second content element and not inclusive of the first content element, the rendering being based on the determination that the first content element is not active with respect to the electronic content.

11. (canceled)

12. The system of claim 10, wherein the rendering module is configured to receive the current time period data, the current time period data being constructed from at least one of output from a clock, input from a user, or a time expression received via a network.

13. The system of claim 10, further comprising an authoring module configured to associate the first content element with the electronic content, and to associate the active time period data with the first content element.

14. A method comprising:
creating association data that associates a first alternate content element with active time period data, the first alternate content element being associated with a page-descriptive electronic document and renderable as being included in the page-descriptive electronic document, the active time period data specifying a time period during which the page-descriptive electronic document includes the first alternate content element, the page-descriptive electronic document being associated with a second alternate content element that is renderable as being included in the page-descriptive electronic document outside of the specified time period, the first and second alternate content elements being alternate paragraphs of the page-descriptive electronic document; and
storing the association data and the active time period data.

15. The method of claim 14, further comprising creating the first content element and associating the first content element with the page-descriptive electronic document.

16. The method of claim 14, wherein the storing of the association data and the active time period data includes storing the association data into a first file and the active time period data into a second file, where the first file and the second file are separate files.

17. The method of claim 14, wherein the storing of the association data storing the association data into a first file and the first content element into a second file, the first file and the second file being separate files.

18. The method of claim 14, wherein the active time period data specifies a discontinuous time period.

19. The method of claim 14, wherein the storing of the association data includes encapsulating the association data within the page-descriptive electronic document.

20. The method of claim 14, wherein the page-descriptive electronic document includes digital data, and wherein the first content element is associated with the page-descriptive electronic document by being a portion of the digital data included in the page-descriptive electronic document.

21. The method of claim 14, wherein the association of the first content element with the page-descriptive electronic document is by inclusion of a reference, within the page-descriptive electronic document, to the first content element.

22. The method of claim 14, further comprising:
creating further association data that associates a further content element with further active time period data, the further content element being associated with the page-descriptive electronic document and renderable as being included in the page-descriptive electronic document, the further active time period data specifying a further time period during which the page-descriptive electronic document includes the further content element; and
storing the further association data.

23. The method of claim 14, wherein the first content element is at least one of a page-descriptive electronic document portion, a digital image, digital video, or digital audio.

24. The method of claim 14, wherein the first content element is a portion of the page-descriptive electronic document.

25. The method of claim 14, wherein the association data includes delimiting data that distinguishes the first content element from the second content element.

26. The method of claim 25, wherein the delimiting data is a pair of tags that reference the active time period data.

27. The method of claim 25, wherein the delimiting data is a file contents table entry that references the active time period data and the first content element.

28. The method of claim 25, wherein the delimiting data is a data structure that references another content element not literally included within the page-descriptive electronic document and references the active time period data.

29. A system comprising:
a processor-implemented association module configured to create association data that associates a first alternate content element with active time period data, the first alternate content element being associated with a page-descriptive electronic document and renderable as being included in the page-descriptive electronic document, the active time period data specifying a time period during which the first alternate content element is active with respect to the page-descriptive electronic document, the page-descriptive electronic document being associated with a second alternate content element that is renderable as being included in the page-descriptive electronic document outside of the specified time period, the first and second alternate content elements being alternate paragraphs of the page-descriptive electronic document; and
a storage access module configured to access the first content element and the second content element, to store the association data, and to store the active time period data.

30. The system of claim 29, wherein the storage access module is configured to store the association data with the active time period data.

31. The system of claim 29, further comprising a content creation module configured to create the first content element and to associate the first content element with the page-descriptive electronic document.

32. The method of claim 31, wherein the storage access module is configured to store the first content element.

33. The system of claim 29, wherein the storage access module is configured to store the association data into a first file and the active time period data into a second file, the first file and the second file being separate files.

34. The system of claim 32, wherein the storage access module is configured to store the association data into a first file and the first content element into a second file, the first file and the second file being separate files.

35. The system of claim 29, wherein the active time period data specifies a discontinuous time period.

36. The system of claim 29, wherein the processor-implemented association module is further configured to encapsulate the association data within the page-descriptive electronic document.

37. The system of claim 29, wherein the page-descriptive electronic document includes digital data, and wherein the first content element is associated with the page-descriptive electronic document by being a portion of the digital data included in the page-descriptive electronic document.

38. The system of claim 29, wherein the association of the first content element with the page-descriptive electronic document is by inclusion of a reference, within the page-descriptive electronic document, to the first content element.

39. The system of claim 29, wherein
the processor-implemented association module is further configured to create further association data that associates a further content element with further active time period data, the further content element being associated with the page-descriptive electronic document and renderable as being included in the page-descriptive electronic document, the further active time period data specifying a further time period during which the further content element is active with respect to the page-descriptive electronic document, and wherein
the storage access module is further configured to store the further association data and to store the further active time period data.

40. The system of claim 29, wherein the first content element is at least one of a portion of an electronic document, a digital image, digital video, or digital audio.

41. The system of claim 29, wherein the first content element is a portion of the page descriptive electronic document.

42. The system of claim 29, wherein the association data includes delimiting data that distinguishes the first content element from the second content element.

43. The system of claim 42, wherein the delimiting data is a pair of tags that reference the active time period data.

44. The method of claim 42, wherein the delimiting data is a file contents table entry that references the active time period data and the first content element.

45. The method of claim 42, wherein the delimiting data is a data structure that references another content element not literally included within the page-descriptive electronic document and references the active time period data.

46. A machine-readable medium, wherein is stored at least one data structure, the at least one data structure comprising:
electronic content of a page-descriptive electronic document;
a first alternate content element associated with the electronic content and renderable as being included in the electronic content;
a second alternate content element associated with the electronic content and renderable as being included in the electronic content;
active time period data; and
association data associating the active time period data with the first alternate content element, the active time period data specifying a time period during which the first alternate content element is included in the electronic content, the second alternate content element being included in the electronic content outside the specified time period, the first and second alternate content elements being alternate paragraphs of the page-descriptive electronic document.

47. A machine-readable medium embodying instructions, which when executed by a machine, cause the machine to perform a method comprising:
creating association data that associates a first alternate content element and active time period data, the first alternate content element being associated with a page-descriptive electronic document and renderable as being included in the page-descriptive electronic document, the active time period data specifying a time period during which the page-descriptive electronic document includes the first alternate content element, the page-descriptive electronic document being associated with a second alternate content element that is renderable as being included in the page-descriptive electronic document outside of the specified time period, the first and second alternate content elements being alternate paragraphs of the page-descriptive electronic document; and
storing the association data.

48. A machine-readable medium embodying instructions, which when executed by a machine, cause the machine to perform a method comprising:
accessing electronic content of a page-descriptive electronic document, the electronic content being associated with a first content element that is renderable as being included in the electronic content, the 1st content element being associated with active time period data, the active time period data specifying a time period during which the first content element is active with respect to the electronic content, electronic content being further associated with a second content element that is renderable as being included in electronic content, at least one of the first and second content elements included within the electronic content of the page-descriptive electronic document, the first and second content elements being alternate paragraphs of the page-descriptive electronic document;
receiving current time period data;
determining whether the association between the electronic content and the first content element is active, the first content element being a first alternate-portion of the page-descriptive electronic document; and
rendering the second content element and not inclusive of the first content element, the second content element being a second alternate-portion of the page-descriptive electronic document, the rendering being based on a determination that the first content element is not active with respect to the electronic content and the rendering of the electronic content as being inclusive of the second content element including presenting a view of second alternate-portion of the page-descriptive electronic document.

49-50. (canceled)
